(19) United States
(12) Patent Application Publication
(10) Pub. No.: US 2025/0278051 A1
(43) Pub. Date: Sep. 4, 2025

(54) IMAGE FORMING APPARATUS

(71) Applicant: BROTHER KOGYO KABUSHIKI KAISHA, Nagoya (JP)

(72) Inventor: Ayaka OHIRA, Nagoya (JP)

(73) Assignee: BROTHER KOGYO KABUSHIKI KAISHA, Nagoya (JP)

(21) Appl. No.: 19/022,418

(22) Filed: Jan. 15, 2025

(30) Foreign Application Priority Data
Feb. 29, 2024 (JP) 2024-030273

(51) Int. Cl. G03G 15/00

(52) U.S. Cl. CPC G03G 15/6579; G03G 15/6561; G03G 15/657; G03G 2215/00405; G03G 2215/00409; G03G 2215/00413; G03G 2215/0043

(57) ABSTRACT

A movable chute is located downstream of a transfer unit and upstream of a fuser in a first direction. A downstream end of the movable chute located at a second position is farther from a sheet conveyance path than the downstream end of the movable chute located at a first position. A reconveyance chute forms a reconveyance path of a sheet that is reconveyed from the fuser toward the transfer unit. The reconveyance path is located between the movable chute and the reconveyance chute in a sheet thickness direction. The movable chute has a sheet conveyance surface and a first reconveyance surface. The sheet conveyance surface guides the sheet that is conveyed from the transfer unit toward the fuser along the sheet conveyance path. The first reconveyance surface faces opposite to the sheet conveyance surface in the sheet thickness direction. The first reconveyance surface forms the reconveyance path.

### REFERENCE TO RELATED APPLICATIONS

This application claims priority from Japanese Patent Application No. 2024-030273 filed on Feb. 29, 2024. The entire content of the priority application is incorporated herein by reference.

### BACKGROUND ART

An image forming apparatus including a transfer unit that transfers a toner image onto a sheet and a fuser that fixes the toner image onto the sheet is known.

### SUMMARY

For example, an image forming apparatus includes a guide member for guiding a sheet from a transfer unit to a fuser, and a reconveyance tray for guiding the sheet which is reversed after passing through the fuser and is conveyed toward the transfer unit.

In such an image forming apparatus, the guide member is configured to be movable, so that the sheet is efficiently conveyed in response to deflection (bending) generated in the sheet conveyed between the transfer unit and the fuser.

However, in the image forming apparatus including the guide member and the reconveyance tray, the reconveyance tray is located between the guide member and a reconveyance path of the sheet conveyed from the fuser to the transfer unit. Thus, in order to prevent the interference (contact) between the reconveyance tray and the guide member, the movement range of the guide member is restricted, and there is a possibility that the sheet cannot be efficiently conveyed.

In view of the foregoing, an example of an object of this disclosure is to provide an image forming apparatus configured to efficiently convey a sheet by preventing restriction of a movement range of a guide member.

According to one aspect, this specification discloses an image forming apparatus. The image forming apparatus includes a transfer unit, a fuser, a movable chute, and a reconveyance chute. The transfer unit is configured to transfer a toner image onto a sheet. The fuser includes a heater and is configured to fix the toner image on the sheet conveyed from the transfer unit. The movable chute is located downstream of the transfer unit and upstream of the fuser in a first direction. The first direction is a sheet conveyance direction from the transfer unit toward the fuser. The movable chute has a downstream end in the first direction. The movable chute is movable between a first position and a second position different from the first position. The downstream end of the movable chute located at the second position is farther from a sheet conveyance path than the downstream end of the movable chute located at the first position. The sheet conveyance path is formed along the first direction. The reconveyance chute is configured to guide the sheet having passed the fuser to the transfer unit. The reconveyance chute forms a reconveyance path of the sheet that is reconveyed from the fuser toward the transfer unit. The reconveyance path is located between the movable chute and the reconveyance chute in a sheet thickness direction of the sheet. The movable chute has a sheet conveyance surface and a first reconveyance surface. The sheet conveyance surface is configured to guide the sheet that is conveyed from the transfer unit toward the fuser along the sheet conveyance path. Thus, the sheet conveyed along the sheet conveyance path is guided by the sheet conveyance surface of the movable chute. The first reconveyance surface faces opposite to the sheet conveyance surface in the sheet thickness direction. The first reconveyance surface forms the reconveyance path. Thus, the sheet conveyed along the reconveyance path is guided by the first reconveyance surface of the movable chute.

According to the present disclosure, the movement range of the movable chute is not restricted when the movable chute is moved to the second position. This secures a large space in which the sheet conveyance path is located, and enables efficient conveyance of the sheet. Further, the number of components constituting the image forming apparatus is reduced, and the image forming apparatus is downsized in the upper-lower direction.

### BRIEF DESCRIPTION OF DRAWINGS

FIG. 1 is a schematic central cross-sectional view showing an image forming apparatus.

FIG. 2 is a perspective view of the image forming apparatus with a front cover in an open position.

FIG. 3 is a perspective view showing a first main body frame, a second main body frame, an air duct, and a movable chute, as viewed from left front.

FIG. 4 is a side cross-sectional view showing a fuser.

FIG. 5 is a perspective view showing a heating unit and a pressure roller of the fuser.

FIG. 6 is a central cross-sectional view showing the image forming apparatus.

FIG. 7 is a side cross-sectional view showing a region between the transfer unit and the fuser in an apparatus main body in a state where the movable chute is at a first position.

FIG. 8 is a side cross-sectional view showing the region between the transfer unit and the fuser in the apparatus main body in a state where the movable chute is at a second position.

FIG. 9 is a perspective view showing the movable chute to which a chute sheet metal is fixed.

FIG. 10 is an exploded perspective view showing the chute sheet metal, the movable chute, and a chute stopper.

FIG. 11A is a plan view showing the movable chute to which the chute sheet metal is fixed.

FIG. 11B is a bottom view showing the movable chute to which the chute sheet metal is fixed.

FIG. 12 is a side cross-sectional view showing the movable chute to which the chute sheet metal is fixed.

FIG. 13 is a perspective view showing a fuser chute, the movable chute, and a guide frame.

FIG. 14 is a bottom view showing the fuser chute, the movable chute, and the guide frame.

FIG. 15 is a cross-sectional view taken along a line XV-XV in FIG. 14.

FIG. 16 is a cross-sectional view taken along a line XVI-XVI in FIG. 14.

FIG. 17 is a block diagram showing a drive mechanism of the movable chute.

FIG. 18 is a rear cross-sectional view showing a chute link in a state of being spaced apart from the movable chute.

FIG. 19 is a rear cross-sectional view showing the chute link in a state of pressing the movable chute;

FIG. 20A is a perspective view showing a movable chute and a chute sheet metal.

FIG. 20B is a plan view showing the movable chute and the chute sheet metal.

FIG. 21 is a bottom view showing a fuser chute and the movable chute.

FIG. 22 is a cross-sectional view taken along a line XXII-XXII in FIG. 21.

FIG. 23 is a side cross-sectional view showing a movable chute in a state of being located at a first position.

FIG. 24 is a side cross-sectional view showing the movable chute in a state of being located at a second position.

### DESCRIPTION

Next, embodiments for carrying out the present disclosure will be described with reference to the accompanying drawings.

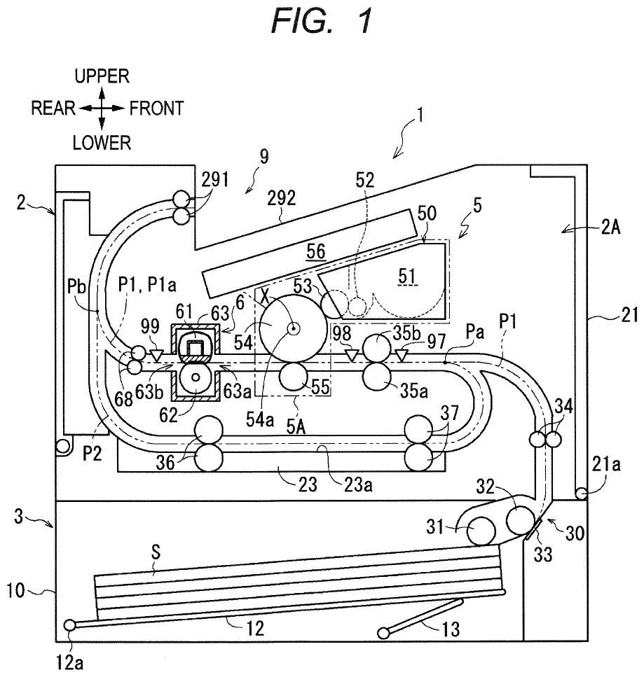

An image forming apparatus 1 shown in FIG. 1 is an embodiment of an image forming apparatus including a sheet conveyor according to the present disclosure. The image forming apparatus 1 is a laser printer that forms an image on a sheet S by an electrophotographic method.

In the following description, the right side in FIG. 1 is defined as the front side of the image forming apparatus 1, the left side in FIG. 1 is defined as the rear side of the image forming apparatus 1, the near side in a direction perpendicular to the drawing sheet of FIG. 1 is defined as the left side of the image forming apparatus 1, and the far side is defined as the right side of the image forming apparatus 1. The upper side and the lower side in FIG. 1 are defined as the upper side and the lower side of the image forming apparatus 1, respectively.

The image forming apparatus 1 includes an apparatus main body 2, a sheet feed unit 3, an image forming unit (print engine) 5, a fuser 6, and a sheet discharge unit 9.

The apparatus main body 2 accommodates the sheet feed unit 3, the image forming unit 5, the fuser 6, and the sheet discharge unit 9. An opening 2A is formed in a front surface of the apparatus main body 2, and the apparatus main body 2 includes a front cover 21 configured to open and close the opening 2A. The front cover 21 is configured to be pivotable about a pivot shaft 21a at a lower end thereof. By pivoting about the pivot shaft 21a, the front cover 21 is movable between a closed position at which the front cover 21 closes the opening 2A and an open position at which the front cover 21 opens the opening 2A.

The sheet feed unit 3 includes a sheet feed tray 10 for supporting the sheet S, a sheet conveyance unit 30, a conveyance roller pair 34, and a registration roller 35a. The sheet feed unit 3 is disposed in a lower part of the apparatus main body 2 and conveys the sheet S supported by the sheet feed tray 10 to the image forming unit 5. The image forming apparatus 1 has a conveyance path P1 for the sheet S from the sheet feed unit 3 to the sheet discharge unit 9 via the image forming unit 5. The conveyance path P1 is an example of a sheet conveyance path.

The sheet feed tray 10 includes a pressure plate 12 and a pressing plate 13. The pressure plate 12 is a plate-like member that supports the sheet S from below. The pressure plate 12 is pivotable about a pivot point 12a at a rear end, and is movable up and down between a lowered position and a raised position by pivoting about the pivot point 12a. The pressing plate 13 is located below the pressure plate 12 and moves the pressure plate 12 up and down between the lowered position and the raised position.

The sheet conveyance unit 30 is a conveyance mechanism that separates and takes out the sheets S supported by the sheet feed tray 10 one sheet at a time and conveys the sheets S toward the image forming unit 5. The sheet conveyance unit 30 includes a sheet feed roller 31, a separation roller 32, and a separation pad 33.

The sheet feed roller 31 is a roller for feeding the sheet S supported by the sheet feed tray 10 toward the separation roller 32. The separation roller 32 is disposed downstream of the sheet feed roller 31 in a sheet conveyance direction. The separation pad 33 is disposed to face the separation roller 32 and is urged toward the separation roller 32.

The sheets S fed toward the separation roller 32 by the sheet feed roller 31 are separated one sheet at a time between the separation roller 32 and the separation pad 33. The sheets S separated one sheet at a time are sent out to the conveyance path P1.

The sheet S sent to the conveyance path P1 is conveyed toward the image forming unit 5 by the conveyance roller pair 34, the registration roller 35a, and a pinch roller 35b disposed to face the registration roller 35a. The registration roller 35a regulates and temporarily stops movement of the leading edge of the sheet S conveyed from the sheet feed tray 10 toward the image forming unit 5, corrects skew of the sheet S, and then conveys the sheet S toward the image forming unit 5 at a particular timing. The registration roller 35a is a roller for correcting the skew of the sheet S conveyed toward a transfer unit 5A included in the image forming unit 5.

The image forming apparatus 1 includes a pre-registration sensor 97 located upstream of the registration roller 35a in the sheet conveyance direction and a post-registration sensor 98 located downstream of the registration roller 35a in the sheet conveyance direction.

The pre-registration sensor 97 is a sensor for detecting the sheet S conveyed along the conveyance path P1. The pre-registration sensor 97 is configured to be turned on upon detecting the leading edge of the sheet S when the leading edge of the sheet S passes the pre-registration sensor 97, and to be turned off upon detecting the trailing edge of the sheet S when the trailing edge of the sheet S passes the pre-registration sensor 97, for example.

The post-registration sensor 98 is a sensor for detecting the sheet S conveyed along the conveyance path P1. The post-registration sensor 98 is configured to be turned on upon detecting the leading edge of the sheet S when the leading edge of the sheet S passes the post-registration sensor 98, and to be turned off upon detecting the trailing edge of the sheet S when the trailing edge of the sheet S passes the post-registration sensor 98, for example.

The image forming unit 5 is disposed downstream of the sheet feed unit 3 in the sheet conveyance direction, and forms an image on the sheet S conveyed from the sheet feed unit 3. The image forming unit 5 includes a process cartridge 50, a transfer roller 55, and an exposure unit 56. The process cartridge 50 forms an image onto a surface of the sheet S conveyed from the sheet feed unit 3. The transfer roller 55 is disposed to face a photosensitive drum 54 of the process cartridge 50. The exposure unit 56 exposes a surface of the photosensitive drum 54. The process cartridge 50 is an example of a cartridge that is attachable to and detachable from the apparatus main body.

The process cartridge 50 is disposed above the sheet feed unit 3 in the apparatus main body 2. The process cartridge 50 includes a developer storage chamber 51, a supply roller 52, a development roller 53, and the photosensitive drum 54. The process cartridge 50 supports the pinch roller 35b.

The process cartridge 50 includes a drum cartridge and a development cartridge. The drum cartridge includes the photosensitive drum 54. The development cartridge is attached to the drum cartridge and includes the development roller 53. The process cartridge 50 is detachably mounted on the apparatus main body 2. In this case, the process cartridge 50 is attached to the apparatus main body 2 by inserting the drum cartridge and the development cartridge attached to the drum cartridge, as a unit, into the apparatus main body 2. The process cartridge 50 is detached from the apparatus main body 2 by pulling the drum cartridge and the development cartridge attached to the drum cartridge, as a unit, out of the apparatus main body 2.

The process cartridge 50 is an example of a cartridge, and may include at least one of a photosensitive drum, a development roller, and a toner container. The process cartridge 50 is attachable to and detachable from the apparatus main body 2 when the front cover 21 is in the open position.

The photosensitive drum 54 is disposed in a posture in which an axis X is along a left-right direction (sheet width direction) in a state where the process cartridge 50 is attached to the apparatus main body 2. The photosensitive drum 54 includes a drum shaft 54a made of metal and extending in an axial direction along the axis X. The photosensitive drum 54 rotates about the drum shaft 54a.

In the present embodiment, the process cartridge 50 includes the drum cartridge having the photosensitive drum 54 and the development cartridge attached to the drum cartridge and having the development roller 53. Alternatively, the process cartridge 50 may be configured to include a cartridge and a toner box. The cartridge includes the photosensitive drum 54 and the development roller 53. The toner box is attached to the cartridge and contains toner.

Further, the image forming apparatus may be configured such that a drum cartridge having the photosensitive drum 54 and a development cartridge having the development roller 53 are separately attached to the apparatus main body 2. That is, the process cartridge 50 may include at least one of a photosensitive drum, a development roller, and a toner container, and may be configured to be attachable to and detachable from the apparatus main body.

The exposure unit 56 includes a laser diode, a polygon mirror, a lens, a reflecting mirror, and so on. The exposure unit 56 irradiates the photosensitive drum 54 with laser light based on image data input to the image forming apparatus 1, thereby exposing the surface of the photosensitive drum 54.

The developer storage chamber 51 stores toner serving as developer. The toner stored in the developer storage chamber 51 is sent to the supply roller 52 while being agitated by an agitating member (not shown). The supply roller 52 further supplies the toner sent from the developer storage chamber 51 to the development roller 53.

The development roller 53 is disposed in close contact with the supply roller 52, and bears the toner supplied from the supply roller 52 and positively charged by a sliding contact member (not shown). A developing bias is applied to the development roller 53 by a bias applying unit (not shown).

The photosensitive drum 54 is disposed adjacent to the development roller 53. The surface of the photosensitive drum 54 is uniformly charged by a charger (not shown) and then exposed by the exposure unit 56. The exposed portion of the photosensitive drum 54 has a lower potential than the other portion, and an electrostatic latent image based on image data is formed on the photosensitive drum 54. Then, positively charged toner is supplied from the development roller 53 to the surface of the photosensitive drum 54 on which the electrostatic latent image is formed, whereby the electrostatic latent image is visualized to form a toner image.

The transfer roller 55 is disposed to face the photosensitive drum 54, and a transfer bias is applied to the transfer roller 55 by a bias applying unit (not shown). In a state where the transfer bias is applied to the surface of the transfer roller 55, the sheet S is nipped and conveyed between the photosensitive drum 54 on which the toner image is formed and the transfer roller 55, whereby the toner image formed on the surface of the photosensitive drum 54 is transferred onto the surface of the sheet S.

The process cartridge 50, the photosensitive drum 54, and the transfer roller 55 constitute the transfer unit 5A for transferring the toner image onto the sheet S. The sheet S to which the toner image has been transferred is conveyed from the transfer unit 5A to the fuser 6. The sheet conveyance direction from the transfer unit 5A toward the fuser 6 along the conveyance path P1 is defined as a first direction D1.

The fuser 6 includes a heating unit 61 and a pressure roller 62, and fixes the image transferred to the sheet S by the transfer unit 5A. The heating unit 61 is heated by supplying electric power from a power source (not shown). The heating unit 61 is an example of a heating unit. The pressure roller 62 is disposed to face the heating unit 61. One of the heating unit 61 and the pressure roller 62 is urged toward the other by an urging mechanism (not shown), and the heating unit 61 and the pressure roller 62 are in close contact with each other.

When the sheet S to which the toner image has been transferred is conveyed to the fuser 6, the sheet S is conveyed while being nipped between the heating unit 61 and the pressure roller 62, and the sheet S is heated, and the toner image is fixed to the sheet S. In this way, the fuser 6 fixes the toner image to the sheet S conveyed from the transfer unit 5A. The sheet S on which the toner image is fixed by the fuser 6 is conveyed to the sheet discharge unit 9 by a post-fixing conveyance roller pair 68 disposed downstream of the fuser 6 in the sheet conveyance direction.

The image forming apparatus 1 includes a sheet sensor 99 located between the fuser 6 and the post-fixing conveyance roller pair 68. The sheet sensor 99 is a sensor for detecting the sheet S conveyed along the conveyance path P1. The sheet sensor 99 is configured to be turned on upon detecting the leading edge of the sheet S when the leading edge of the sheet S passes the sheet sensor 99, and to be turned off upon detecting the trailing edge of the sheet S when the trailing edge of the sheet S passes the sheet sensor 99, for example.

The sheet discharge unit 9 is located downstream of the post-fixing conveyance roller pair 68 in the sheet conveyance direction. The sheet discharge unit 9 discharges the sheet S on which the image is formed by the image forming unit 5 to the outside of the image forming apparatus 1, or conveys the sheet S again toward the image forming unit 5. The sheet discharge unit 9 includes a sheet discharge roller pair 291 and a sheet discharge tray 292. The sheet discharge tray 292 is provided at the apparatus main body 2. The printed sheet S on which an image is formed in the image forming unit 5 is discharged to the sheet discharge tray 292.

The conveyance path P1 on the downstream side of the fuser 6 in the conveyance path P1 is formed as a discharge path P1a. The sheet discharge roller pair 291 is configured to discharge the sheet S conveyed from the fuser 6 along the discharge path P1a toward the outside of the apparatus main body 2. The discharge path P1a is a path for guiding the printed sheet S to the discharge tray 292. The sheet discharge tray 292 is formed on the upper surface of the apparatus main body 2 and supports the sheet S discharged to the outside of the apparatus main body 2 by the sheet discharge roller pair 291.

The sheet discharge roller pair 291 is configured to be rotatable in a discharge direction which is a rotation direction for conveying the sheet S toward the sheet discharge tray 292 and a reconveyance direction which is a rotation direction opposite to the discharge direction. The image forming apparatus 1 includes a reconveyance path P2 that guides the one-side printed sheet S, which has been conveyed along the conveyance path P1 and passed the fuser 6, to the conveyance path P1 on the upstream side of the registration roller 35a in the sheet conveyance direction.

The reconveyance path P2 branches from the discharge path P1a at a branch point Pb located between the post-fixing conveyance roller pair 68 and the discharge roller pair 291, extends forward between the image forming unit 5 and the sheet feed tray 10, and joins the conveyance path P1 at a merging point Pa located between the conveyance roller pair 34 and the registration roller 35a.

The sheet S conveyed from the fuser 6 to the sheet discharge unit 9 is conveyed again to the image forming unit 5 through the reconveyance path P2 by reversing the rotation direction of the sheet discharge roller pair 291 to rotate in the reconveyance direction. The sheet S conveyed to the reconveyance path P2 by the sheet discharge roller pair 291 is conveyed toward the image forming unit 5 by a first reconveyance roller pair 36 and a second reconveyance roller pair 37 provided on the reconveyance path P2.

The sheet S conveyed along the reconveyance path P2 is conveyed to the transfer unit 5A of the image forming unit 5 after passing through the merging point Pa. Thus, the reconveyance path P2 is a conveyance path of the sheet S conveyed from the fuser 6 toward the transfer unit 5A. The sheet conveyance direction of the sheet S conveyed along the reconveyance path P2 toward the transfer unit 5A is a second direction D2.

The image forming apparatus 1 is configured to perform duplex printing in which the sheet S having an image formed on one side thereof by the image forming unit 5 is conveyed again to the image forming unit 5 through the reconveyance path P2 and an image is formed on the other side of the sheet S.

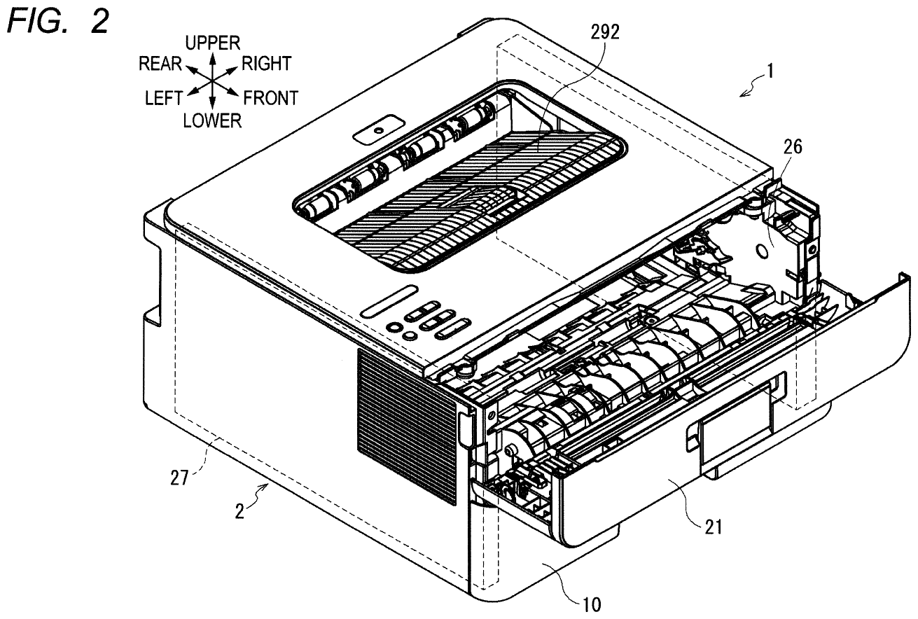

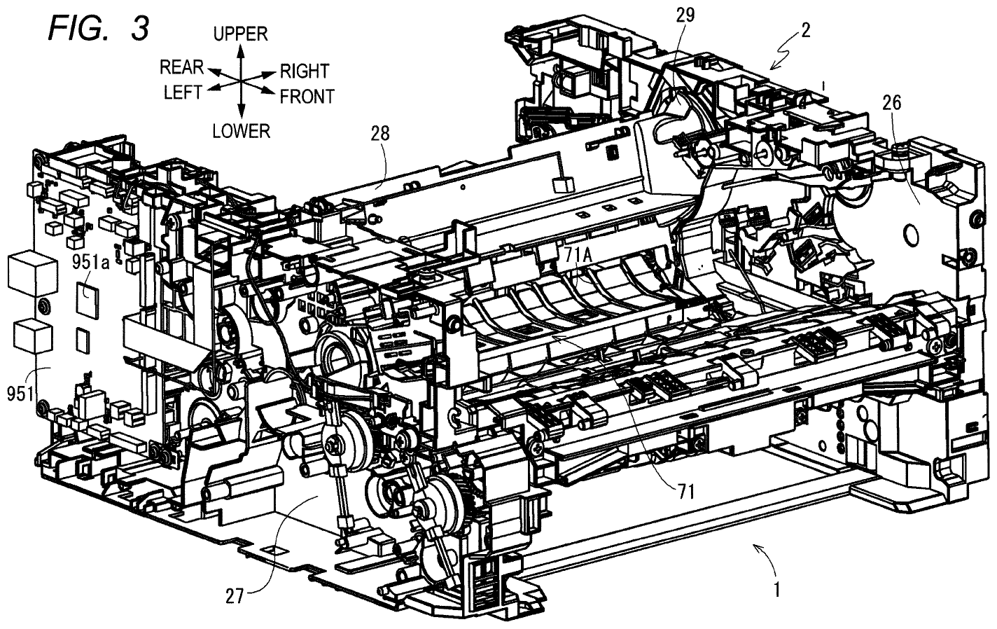

As shown in FIGS. 2 and 3, the apparatus main body 2 includes a first main body frame 26 and a second main body frame 27 which are disposed to be separated from each other in the left-right direction. The first main body frame 26 is located at a right end of the apparatus main body 2, and the second main body frame 27 is located at a left end of the apparatus main body 2. The first main body frame 26 extends in the front-rear direction and the upper-lower direction, and is disposed in a posture in which a plate surface faces in the left-right direction. The second main body frame 27 extends in the front-rear direction and the upper-lower direction, and is disposed in a posture in which a plate surface faces in the left-right direction.

The fuser 6 and the transfer unit 5A including the process cartridge 50 are disposed between the first main body frame 26 and the second main body frame 27. The first main body frame 26 is disposed on the right side of the transfer unit 5A and the fuser 6, and the second main body frame 27 is disposed on the left side of the transfer unit 5A and the fuser 6. The process cartridge 50 constituting the transfer unit 5A is detachably supported by the first main body frame 26 and the second main body frame 27.

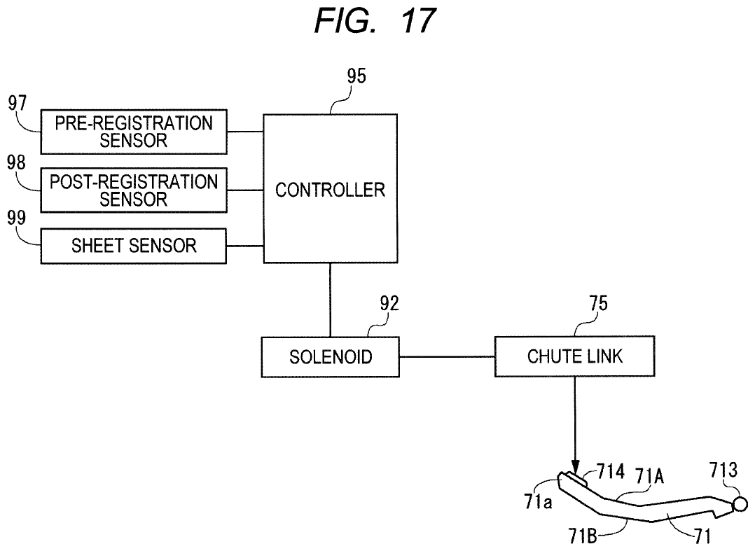

The first main body frame 26 supports a fan 29 for discharging air in the apparatus main body 2 to the outside of the apparatus main body 2. The second main body frame 27 supports a control board 951 on which electronic components such as a CPU 951a are mounted. The control board 951 constitutes a controller 95 (see FIG. 17) for controlling the operation of the image forming apparatus 1.

An air duct 28 extending along the left-right direction is disposed between the first main body frame 26 and the second main body frame 27. The air duct 28 is provided to span between the first main body frame 26 and the second main body frame 27. The right end of the air duct 28 is supported by the first main body frame 26, and the left end of the air duct 28 is supported by the second main body frame 27.

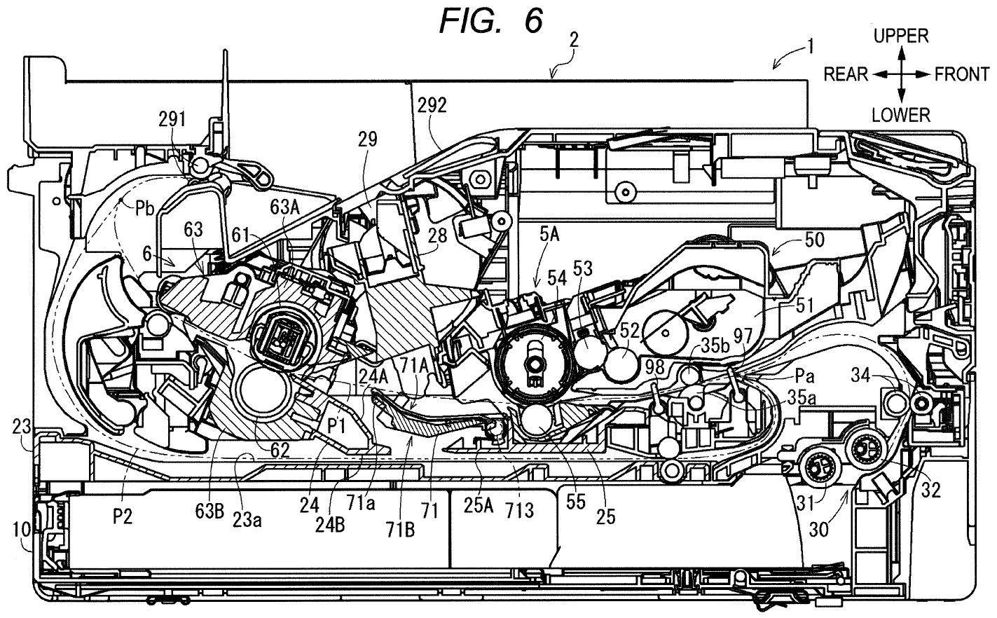

As shown in FIG. 6, the air duct 28 is located between the transfer unit 5A and the fuser 6 in the front-rear direction. The air duct 28 is disposed at a position overlapping the fan 29 when viewed in the left-right direction. Air flows through the air duct 28. The air duct 28 guides air in the apparatus main body 2 toward the fan 29.

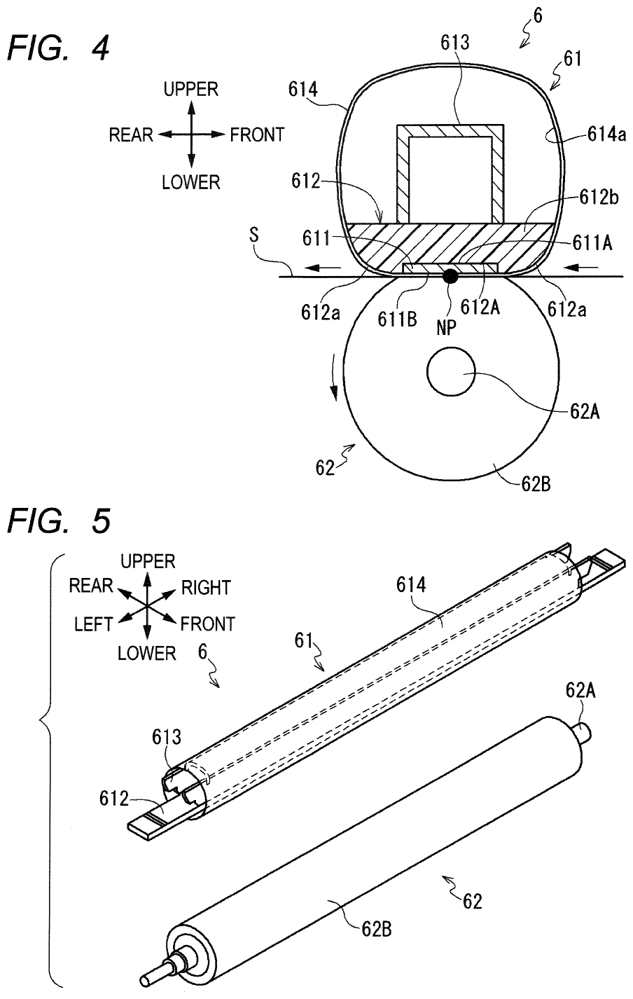

As shown in FIGS. 4 and 5, the heating unit 61 of the fuser 6 includes a heater 611, a holder 612, a stay 613, and a belt 614. The heater 611 is a plate-like heater extending in the left-right direction. The heater 611 has a first surface 611A and a second surface 611B opposite to the first surface 611A. The first surface 611A is supported by the holder 612.

The holder 612 is made of, for example, a plastic member, and has a guide surface 612a and a support wall 612b. The guide surface 612a contacts an inner peripheral surface 614a of the belt 614 to guide the belt 614. The support wall 612b has a support surface 612A that supports the heater 611. The support surface 612A of the support wall 612b contacts the first surface 611A of the heater 611. The stay 613 is a member that supports the holder 612, and is formed by bending a plate material having a rigidity higher than that of the holder 612, for example, a steel plate, into a substantially U-shape in cross-section.

The belt 614 is an endless belt having heat resistance and flexibility, and may include a metal tube made of metal such as stainless steel and a fluororesin layer covering the metal tube. The heater 611, the holder 612, and the stay 613 are disposed inside the belt 614. The belt 614 is configured to rotate around the heater 611, the holder 612, and the stay 613. The inner peripheral surface 614a of the belt 614 contacts the heater 611.

The pressure roller 62 includes a metal shaft 62A and an elastic layer 62B covering the shaft 62A. The pressure roller 62 is pressed against the heater 611 via the belt 614. The pressure roller 62 and the heater 611 sandwich the belt 614 therebetween, thereby forming a nip NP for heating and pressurizing the sheet S. That is, the pressure roller 62 forms the nip NP with the belt 614, and heats and presses the sheet S together with the heater 611 at the nip NP.

The pressure roller 62 is driven to rotate by a driving force transmitted from a motor included in the image forming apparatus 1. The pressure roller 62 is rotationally driven to cause the belt 614 to rotate by a frictional force with the sheet S nipped at the nip NP. Thus, the sheet S on which the toner image is transferred is conveyed between the pressure roller 62 and the heated belt 614, and the toner image is thermally fixed.

As shown in FIGS. 1 and 6 to 8, the fuser 6 includes a fuser frame 63 that covers the heating unit 61 and the pressure roller 62. The fuser frame 63 holds the heating unit 61 and the pressure roller 62. The fuser frame 63 covers the periphery of the heating unit 61 and the pressure roller 62. The fuser frame 63 has a first opening 63a formed upstream of the heating unit 61 and the pressure roller 62 in the first direction D1, and a second opening 63b formed downstream of the heating unit 61 and the pressure roller 62 in the first direction D1.

The fuser frame 63 includes an upper frame 63A and a lower frame 63B. The upper frame 63A is located above the lower frame 63B. The upper frame 63A covers the heating unit 61, and the lower frame 63B covers the pressure roller 62.

In the present embodiment, the fuser 6 includes the heating unit 61 having the heater 611 and the belt 614, and the pressure roller 62. Alternatively, the fuser 6 may include a heating roller having a heater therein and a pressure roller pressed against the heating roller. Alternatively, the fuser 6 may include a heating roller having a heater therein and a pressure belt pressed against the heating roller by an elastic member.

As shown in FIGS. 1 and 6, the apparatus main body 2 includes a reconveyance chute 23 that forms the reconveyance path P2. The reconveyance chute 23 is disposed between the sheet feed tray 10 and the transfer unit 5A in the upper-lower direction. The reconveyance chute 23 is located below the reconveyance path P2, and has a lower chute surface 23a that forms a lower surface of the reconveyance path P2. The reconveyance chute 23 guides the sheet S that has passed the fuser 6 and has been reversed to the transfer unit 5A along the reconveyance path P2.

The reconveyance chute 23 is detachably attached to the apparatus main body 2. The reconveyance chute 23 is configured to be movable in the front-rear direction. The reconveyance chute 23 attached to the apparatus main body 2 is detached from the apparatus main body 2 by being pulled out rearward.

As shown in FIGS. 6 to 8, the image forming apparatus 1 includes a fuser chute 24. The fuser chute 24 is located upstream of the fuser 6 in the first direction D1 and is supported by the lower frame 63B of the fuser frame 63. The fuser chute 24 is located below the conveyance path P1 and forms a lower surface of the conveyance path P1. The fuser chute 24 has a sheet conveyance surface 24A facing upward. The fuser chute 24 forms the lower surface of the conveyance path P1 by the sheet conveyance surface 24A. The sheet conveyance surface 24A guides the lower side of the sheet S conveyed along the conveyance path P1.

The fuser chute 24 is located above the reconveyance path P2 and forms an upper surface of the reconveyance path P2. The fuser chute 24 has a third reconveyance surface 24B facing downward. The third reconveyance surface 24B is a surface opposite to the sheet conveyance surface 24A in the upper-lower direction, and faces the reconveyance path P2. The fuser chute 24 forms an upper surface of the reconveyance path P2 by the third reconveyance surface 24B. The third reconveyance surface 24B guides the upper side of the sheet S conveyed along the reconveyance path P2.

In this way, the upper surface of the reconveyance path P2 is formed by the third reconveyance surface 24B of the fuser chute 24. Thus, it is not necessary to provide a member forming the upper surface of the reconveyance path P2 separately from the fuser chute 24, which reduces the number of components. Further, the size of the apparatus main body 2 in the upper-lower direction is reduced.

As shown in FIGS. 6 to 8, the image forming apparatus 1 includes a movable chute 71. The movable chute 71 is located between the transfer unit 5A and the fuser 6 in the front-rear direction. That is, the movable chute 71 is located downstream of the transfer unit 5A and upstream of the fuser 6 in the first direction D1. The fuser chute 24 is located downstream of the movable chute 71 in the first direction D1.

The movable chute 71 is located on the opposite side of the reconveyance chute 23 with the reconveyance path P2 interposed therebetween in the upper-lower direction, which is the thickness direction of the sheet S conveyed along the conveyance path P1. The movable chute 71 is located above the reconveyance chute 23. The movable chute 71 is located below the conveyance path P1. That is, the movable chute 71 is located between the conveyance path P1 and the reconveyance path P2 in the upper-lower direction.

The movable chute 71 has a sheet conveyance surface 71A facing upward and a first reconveyance surface 71B facing downward. That is, the first reconveyance surface 71B faces toward the opposite side of the sheet conveyance surface 71A in the upper-lower direction. The sheet conveyance surface 71A guides, from below, the sheet S being conveyed along the conveyance path P1 toward the fuser 6. The first reconveyance surface 71B guides, from above, the sheet S being conveyed along the reconveyance path P2 toward the transfer unit 5A. The first reconveyance surface 71B forms an upper surface of the reconveyance path P2.

In this way, the upper surface of the reconveyance path P2 is formed by the first reconveyance surface 71B of the movable chute 71 located above the reconveyance chute 23. Thus, it is not necessary to provide a member forming the upper surface of the reconveyance path P2 separately from the movable chute 71, which reduces the number of components. Further, the size of the apparatus main body 2 in the upper-lower direction is reduced.

In the image forming apparatus 1, the movable chute 71 is located on the opposite side of the reconveyance chute 23 with the reconveyance path P2 interposed therebetween, and the movable chute 71 forms the reconveyance path P2. Thus, when the movable chute 71 is moved to a second position described later, the movement range of the movable chute 71 is not restricted. This secures a large space in which the conveyance path P1 is located (that is, a large space for the conveyance path P1), and the sheet S is conveyed efficiently. Further, the number of components constituting the apparatus main body 2 is reduced, and the apparatus main body 2 is downsized in the upper-lower direction.

In particular, the first reconveyance surface 71B forms the reconveyance path P2 when the movable chute 71 is located at the second position. Thus, the reconveyance path P2 is formed by the movable chute 71 in a state where a large space for the conveyance path P1 is secured.

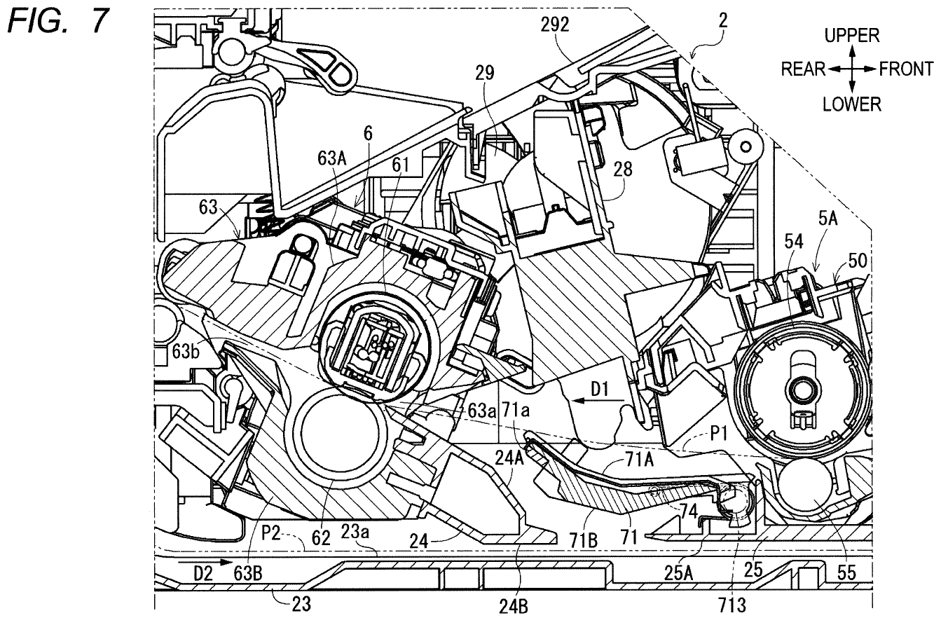

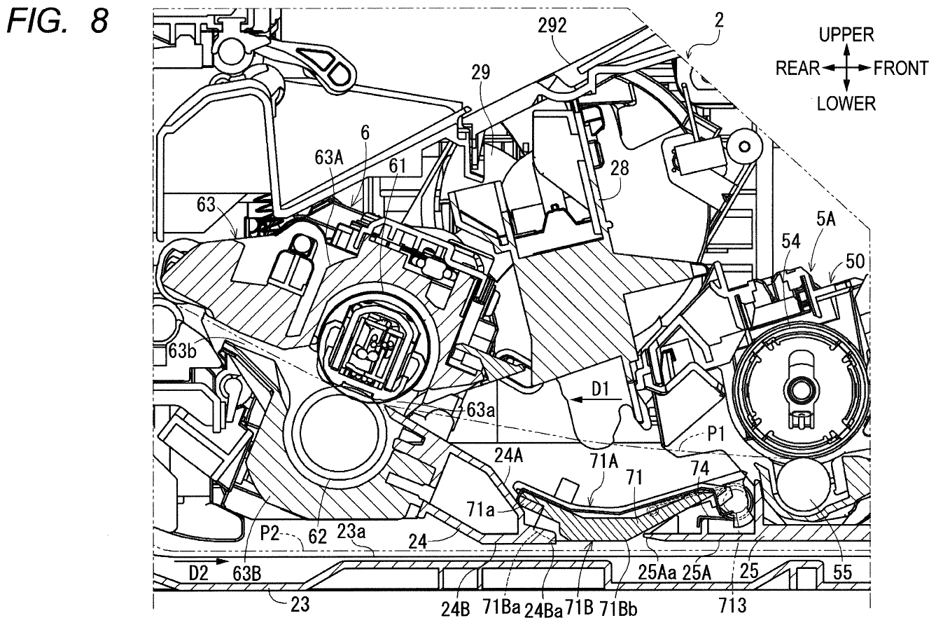

The movable chute 71 is pivotable about a pivot shaft 713 located at the front end. The movable chute 71 is pivotable about the pivot shaft 713 to be movable between a first position (position shown in FIG. 7) and the second position (position shown in FIG. 8) at which a downstream end 71a of the movable chute 71 in the first direction D1 is farther from the conveyance path P1 compared to when the movable chute 71 is located at the first position. When the movable chute 71 moves from the first position to the second position, the downstream end 71a of the movable chute 71 in the first direction D1 contacts the sheet conveyance surface 24A of the fuser chute 24, thereby positioning the movable chute 71 at the second position.

When the movable chute 71 is located at the first position, the sheet conveyance surface 71A of the movable chute 71 guides the sheet S conveyed from the transfer unit 5A toward the fuser 6. When the movable chute 71 is located at the second position, the sheet conveyance surface 71A is located farther away from the conveyance path P1 compared to when the movable chute 71 is located at the first position.

When the sheet S is conveyed by the photosensitive drum 54 and the transfer roller 55 of the transfer unit 5A and by the fuser 6, the conveyance speed of the sheet S by the transfer unit 5A is higher than the conveyance speed of the sheet S by the fuser 6, and the sheet S between the fuser 6 and the transfer unit 5A is bent (curved). When the movable chute 71 is located at the second position, the sheet conveyance surface 71A guides the sheet S bent (curved) toward the sheet conveyance surface 71A between the fuser 6 and the transfer unit 5A.

In this way, the sheet S is guided by the movable chute 71 located at the first position closer to the conveyance path P1 than at the second position. Thus, the sheet conveyed from the transfer unit 5A constituted by the photosensitive drum 54 and the transfer roller 55 is appropriately guided to the fuser 6 by the movable chute 71.

The position of the downstream end 71a of the movable chute 71 when the movable chute 71 is located at the second position is lower than the position of the downstream end 71a of the movable chute 71 when the movable chute 71 is located at the first position. Thus, when the movable chute 71 moves to the second position, a large space is secured in which the conveyance path P1 between the transfer unit 5A and the fuser 6 is located, which prevents the bent (curved) sheet S from interfering with (contacting) other components of the apparatus main body 2.

The first reconveyance surface 71B of the movable chute 71 is located closer to the reconveyance path P2 when the movable chute 71 is located at the second position than when the movable chute 71 is located at the first position. When the movable chute 71 is located at the second position, the first reconveyance surface 71B forms an upper surface of the reconveyance path P2. When the movable chute 71 is located at the second position, the first reconveyance surface 71B guides the upper side of the sheet S conveyed along the reconveyance path P2.

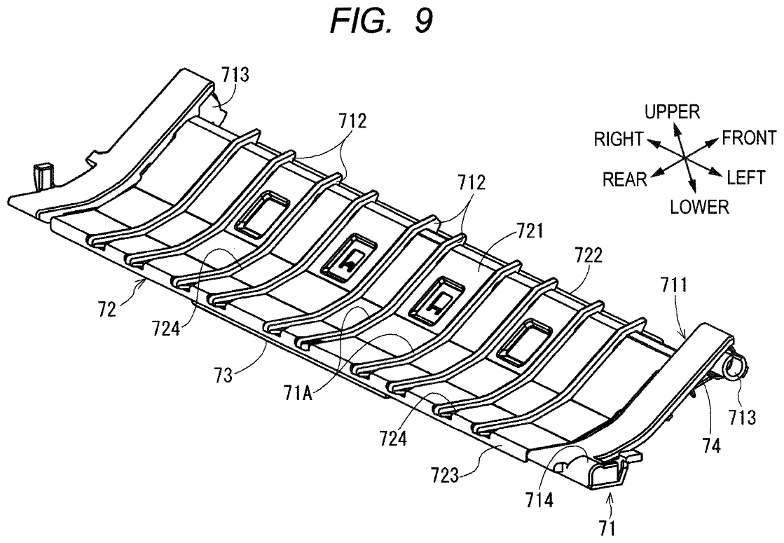

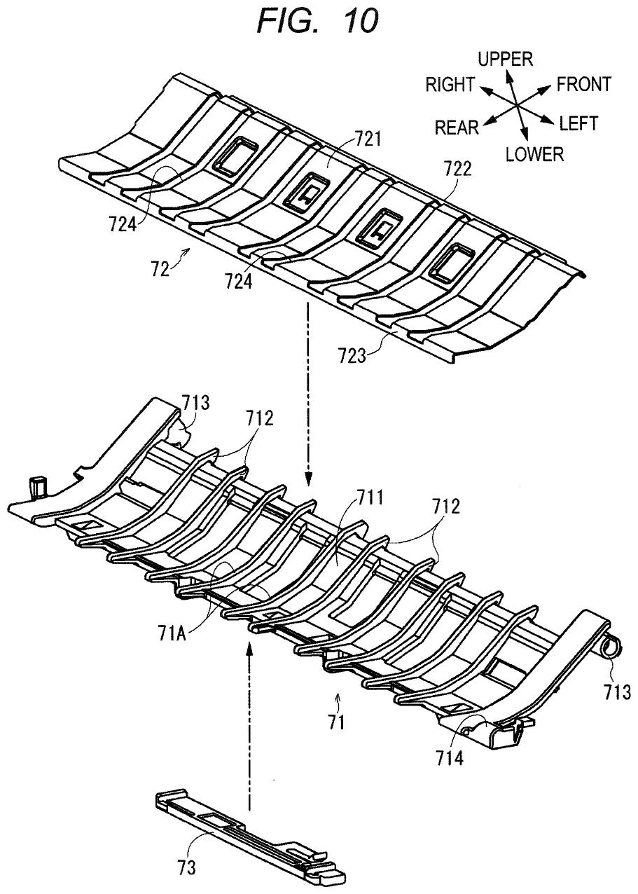

As shown in FIGS. 9 to 12, the movable chute 71 includes a base portion 711, a plurality of guide ribs 712, and the pivot shaft 713. The movable chute 71 is made of a material containing, for example, polyethylene terephthalate (PET) and glass resin.

The base portion 711 is formed of a plate-like member curved so as to be recessed downward when viewed in the left-right direction, and extends in the front-rear direction and the left-right direction. Each guide rib 712 protrudes upward from the upper surface of the base portion 711 and extends in the front-rear direction. The plurality of guide ribs 712 are arranged at intervals along the left-right direction. The front ends of the guide ribs 712 protrude forward from the base portion 711. The rear ends of the guide ribs 712 protrude rearward from the base portion 711. The upper surfaces of the guide ribs 712 form the sheet conveyance surface 71A of the movable chute 71.

The lower surface of the base portion 711 forms the first reconveyance surface 71B of the movable chute 71. The first reconveyance surface 71B has a rear end 71Ba which is an upstream end in the second direction D2 and a front end 71Bb which is a downstream end in the second direction D2.

The pivot shafts 713 are located at the front end of the base portion 711. The pivot shafts 713 are provided at left and right ends of the base portion 711.

A chute sheet metal 72 is placed on the upper surface of the movable chute 71. The chute sheet metal 72 is supported by the movable chute 71. The chute sheet metal 72 is formed of a metal member and is connected to ground. The chute sheet metal 72 is an example of a sheet metal member. The chute sheet metal 72 includes a base portion 721, an upstream flange 722, a downstream flange 723, and a plurality of slits 724.

The base portion 721 is formed of a plate-like member curved along the curved base portion 711 of the movable chute 71. The upstream flange 722 extends downward from a front end of the base portion 721, which is an upstream end of the base portion 721 in the first direction D1, and then extends forward. The downstream flange 723 extends downward from a rear end of the base portion 721, which is a downstream end of the base portion 721 in the first direction D1.

The plurality of slits 724 are formed, and each of the slits extends in the front-rear direction. The plurality of slits 724 are arranged at intervals along the left-right direction. Each slit 724 is a hole through which the guide rib 712 of the movable chute 71 passes from below. The chute sheet metal 72 is superposed on the upper surface of the movable chute 71 in a state where the guide ribs 712 of the movable chute 71 pass through the slits 724 from below. By superposing the chute sheet metal 72 on the movable chute 71, the rigidity of the movable chute 71 is increased by the chute sheet metal 72.

The grounded chute sheet metal 72 is superposed on the movable chute 71. Thus, when the sheet S charged by passing through the transfer unit 5A is guided by the movable chute 71, the sheet S is attracted to the chute sheet metal 72, which prevents the sheet S from moving around (flapping) while being conveyed. Thus, the sheet S is stably conveyed.

The front end of the slit 724 is engaged with the front end of the guide rib 712, and the rear end of the slit 724 is engaged with the rear end of the guide rib 712. This prevents the chute sheet metal 72 superposed on the movable chute 71 from moving upward with respect to the movable chute 71.

The movable chute 71 and the chute sheet metal 72 are fixed by a chute stopper 73. The chute stopper 73 is an example of a stopper. The chute stopper 73 is formed of a plate-like member. The chute stopper 73 is formed of, for example, an ABS resin. The chute stopper 73 is attached to a position at a rear end and a left-right center of the movable chute 71. The chute stopper 73 is attached to the movable chute 71 from the first reconveyance surface 71B side of the movable chute 71.

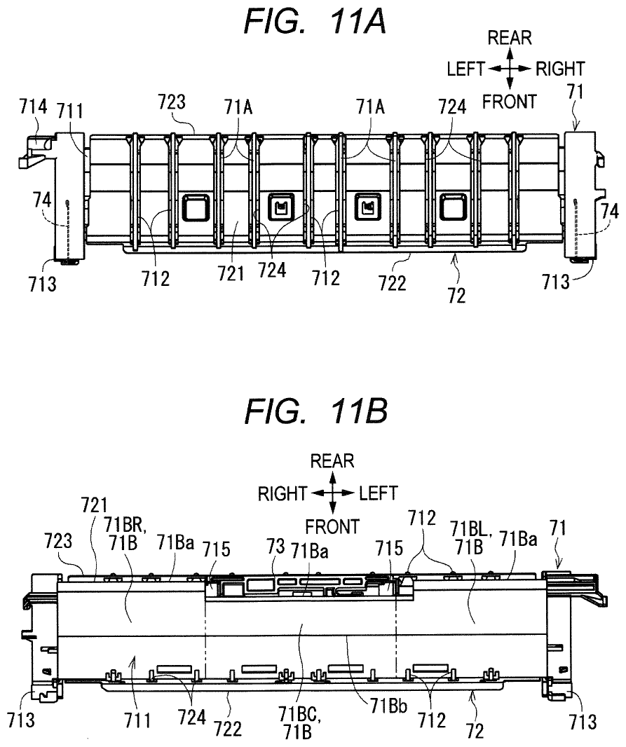

As shown in FIGS. 11A and 11B, the first reconveyance surface 71B of the movable chute 71 includes a central reconveyance surface 71BC, a left reconveyance surface 71BL, and a right reconveyance surface 71BR. The central reconveyance surface 71BC is located at the center of the first reconveyance surface 71B in the left-right direction. The left reconveyance surface 71BL is located to the left of the central reconveyance surface 71BC. The right reconveyance surface 71BR is located to the right of the central reconveyance surface 71BC.

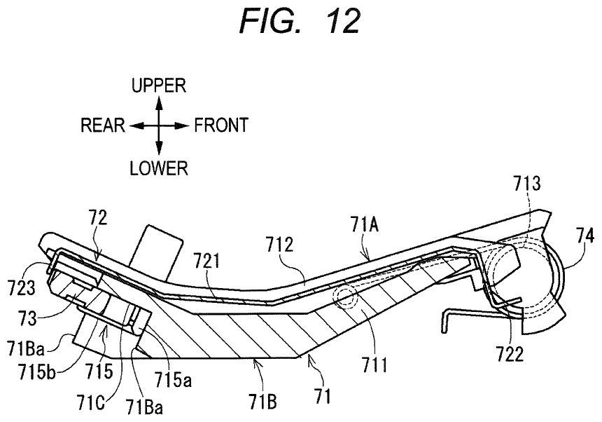

The rear end 71Ba of the central reconveyance surface 71BC is recessed forward from the rear ends 71Ba of the left reconveyance surface 71BL and the right reconveyance surface 71BR. A stopper attachment surface 71C is formed on the base portion 711 at a position rearward of the rear end 71Ba of the central reconveyance surface 71BC (see FIG. 12). The stopper attachment surface 71C faces downward. The stopper attachment surface 71C is located above the central reconveyance surface 71BC.

As shown in FIGS. 11A, 11B and 12, the movable chute 71 includes a holding portion 715. The holding portion 715 is disposed on the stopper attachment surface 71C of the base portion 711. The holding portion 715 includes a first wall 715a that protrudes downward from the stopper attachment surface 71C of the base portion 711, and a second wall 715b that protrudes rearward from the lower end of the first wall 715a. The holding portions 715 are provided at left and right positions (two positions) of the stopper attachment surface 71C, and hold the left end and the right end of the chute stopper 73.

The chute stopper 73 attached to the movable chute 71 is sandwiched between the base portion 711 and the second wall 715b of the holding portion 715 in the upper-lower direction. In this way, the chute stopper 73 is held by the holding portion 715. The chute stopper 73 attached to the movable chute 71 covers the stopper attachment surface 71C from below.

The chute stopper 73 attached to the movable chute 71 is sandwiched between the downstream flange 723 of the chute sheet metal 72 and the first wall 715a of the holding portion 715 in the front-rear direction. This prevents movement of the chute sheet metal 72 in the front-rear direction with respect to the movable chute 71, and the chute sheet metal 72 is fixed with respect to the movable chute 71.

A chute spring 74 engages with the left and right pivot shafts 713 of the movable chute 71. The chute spring 74 is a torsion spring. The chute spring 74 urges the movable chute 71 in a direction from the second position toward the first position.

As shown in FIGS. 6 to 8, the image forming apparatus 1 includes a guide frame 25. The guide frame 25 is located upstream of the movable chute 71 in the first direction D1, and pivotably supports the movable chute 71. The guide frame 25 is located below the transfer unit 5A. The guide frame 25 rotatably supports the registration roller 35a.

The guide frame 25 is located above the reconveyance path P2 and forms an upper surface of the reconveyance path P2. The guide frame 25 has a second reconveyance surface 25A facing downward. The second reconveyance surface 25A faces the reconveyance path P2. The guide frame 25 forms an upper surface of the reconveyance path P2 by the second reconveyance surface 25A. The second reconveyance surface 25A guides the upper side of the sheet S conveyed along the reconveyance path P2.

In this way, the upper surface of the reconveyance path P2 is formed by the second reconveyance surface 25A of the guide frame 25. Thus, it is not necessary to provide a member for forming the upper surface of the reconveyance path P2 separately from the guide frame 25, which reduces the number of components. Further, the size of the apparatus main body 2 in the upper-lower direction is reduced.

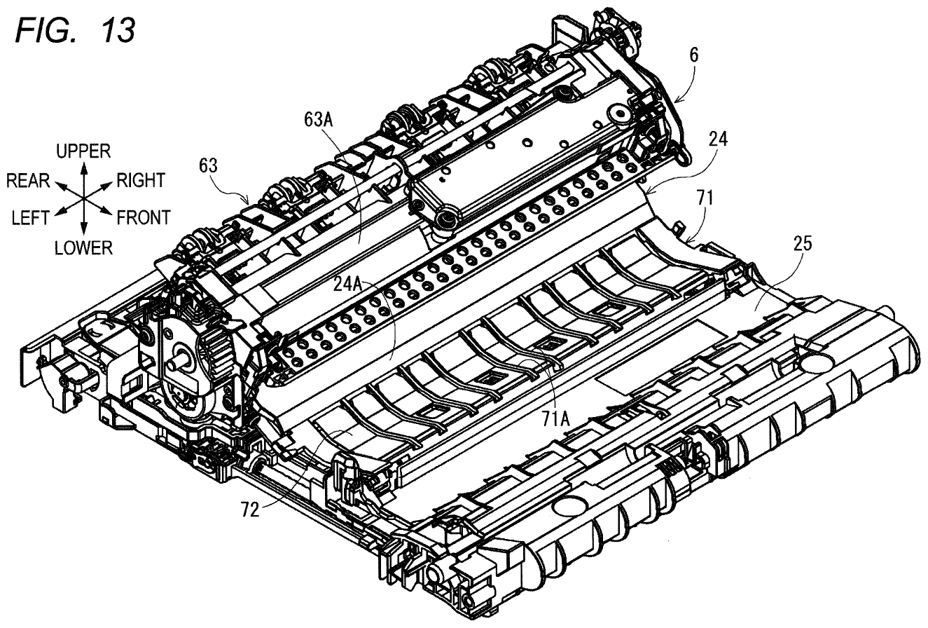

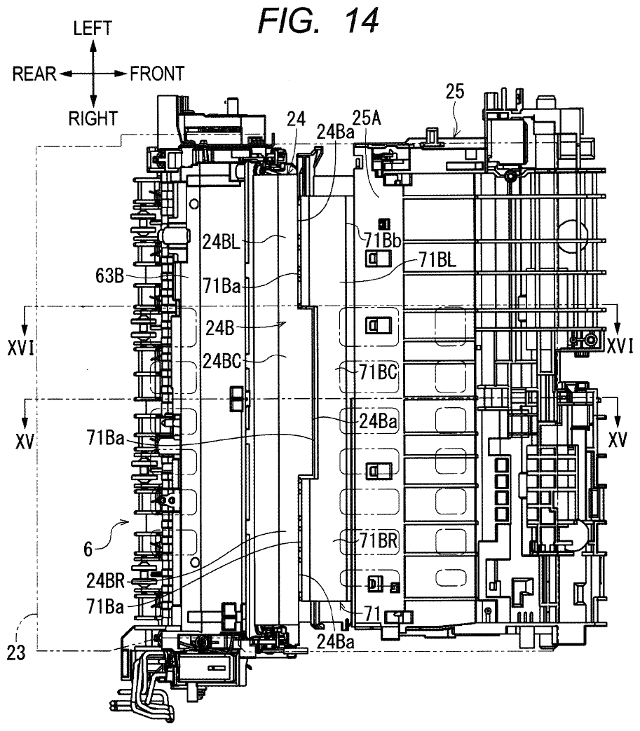

Positional relationships among the fuser chute, the movable chute, and the guide frame will be described. As shown in FIGS. 13 to 16, the third reconveyance surface 24B of the fuser chute 24 includes a central reconveyance surface 24BC, a left reconveyance surface 24BL, and a right reconveyance surface 24BR. The central reconveyance surface 24BC is located at the center of the third reconveyance surface 24B in the left-right direction. The left reconveyance surface 24BL is located to the left of the central reconveyance surface 24BC. The right reconveyance surface 24BR is located to the right of the central reconveyance surface 24BC.

Each of the central reconveyance surface 24BC, the left reconveyance surface 24BL, and the right reconveyance surface 24BR has a front end 24Ba which is a downstream end of the third reconveyance surface 24B of the fuser chute 24. The front end 24Ba of the central reconveyance surface 24BC protrudes forward from the front ends 24Ba of the left reconveyance surface 24BL and the right reconveyance surface 24BR.

The front ends 24Ba of the left reconveyance surface 24BL and the right reconveyance surface 24BR of the third reconveyance surface 24B of the fuser chute 24 are located rearward of the rear end 71Ba of the first reconveyance surface 71B of the movable chute 71. In contrast, the front end 24Ba of the central reconveyance surface 24BC of the third reconveyance surface 24B of the fuser chute 24 is located forward of the rear ends 71Ba of the left reconveyance surface 71BL and the right reconveyance surface 71BR of the movable chute 71.

That is, a portion of the fuser chute 24 where the central reconveyance surface 24BC is formed and portions of the movable chute 71 where the left reconveyance surface 71BL and the right reconveyance surface 71BR are formed overlap each other in the second direction D2. Thus, when the sheet S conveyed along the reconveyance path P2 is guided by the third reconveyance surface 24B of the fuser chute 24 and the first reconveyance surface 71B of the movable chute 71, the sheet S is guided seamlessly by the fuser chute 24 and the movable chute 71. Thus, the sheet S conveyed along the reconveyance path P2 is smoothly handed over from the fuser chute 24 to the movable chute 71.

The front end 24Ba of the central reconveyance surface 24BC of the fuser chute 24 is located rearward of the rear end 71Ba of the central reconveyance surface 71BC of the movable chute 71.

A front end portion of the central reconveyance surface 24BC of the third reconveyance surface 24B of the fuser chute 24 is located below the stopper attachment surface 71C of the movable chute 71, and covers the chute stopper 73 attached to the stopper attachment surface 71C from below. That is, the movable chute 71 and the chute stopper 73 overlap each other when viewed in the upper-lower direction.

Thus, even when the chute stopper 73 is attached to the movable chute 71, the sheet S conveyed along the reconveyance path P2 does not interfere with (contact) the chute stopper 73 when the sheet S is conveyed from the third reconveyance surface 24B to the first reconveyance surface 71B. Thus, the sheet S is smoothly handed over from the fuser chute 24 to the movable chute 71.

The central reconveyance surface 24BC of the third reconveyance surface 24B of the fuser chute 24, and the left reconveyance surface 71BL and the right reconveyance surface 71BR of the first reconveyance surface 71B of the movable chute 71 overlap each other when viewed in the left-right direction.

Thus, when the sheet S conveyed along the reconveyance path P2 is guided by the third reconveyance surface 24B and the first reconveyance surface 71B, the sheet S is guided by both the third reconveyance surface 24B and the first reconveyance surface 71B at a boundary between the third reconveyance surface 24B and the first reconveyance surface 71B. Thus, the sheet S conveyed along the reconveyance path P2 is smoothly handed over from the fuser chute 24 to the movable chute 71.

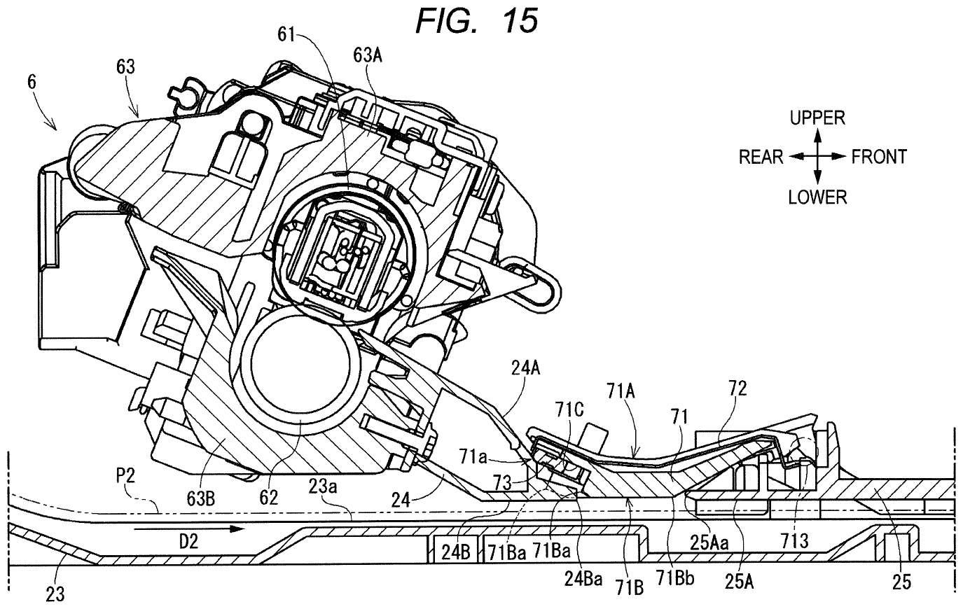

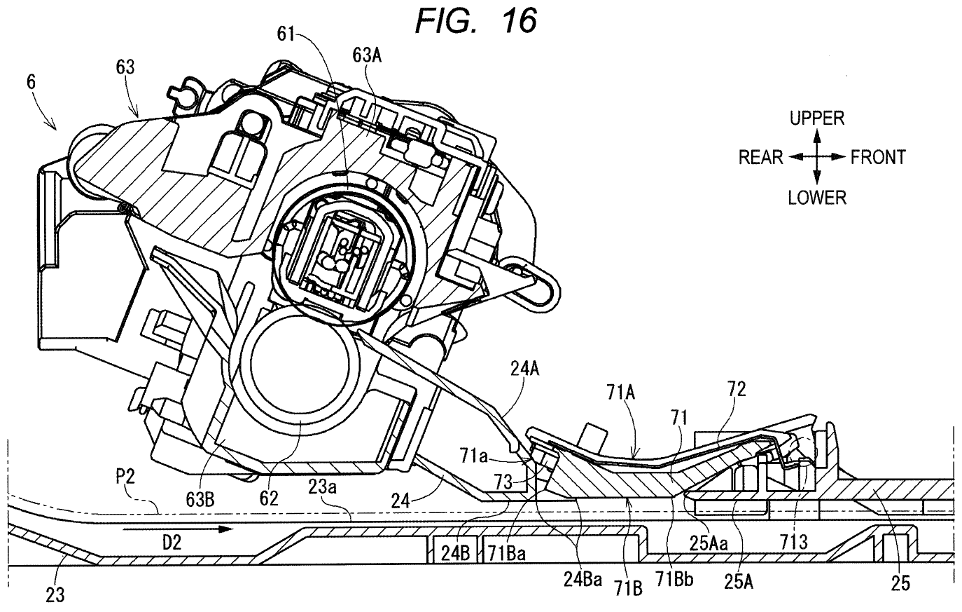

As shown in FIGS. 15 and 16, in a state where the movable chute 71 is located at the second position, a rear end 71Ba of the movable chute 71, which is an upstream end of the first reconveyance surface 71B in the second direction D2, is located farther from the reconveyance path P2 than the front end 24Ba of the fuser chute 24, which is a downstream end of the third reconveyance surface 24B in the second direction D2. That is, the rear end 71Ba of the first reconveyance surface 71B is located above the front end 24Ba of the third reconveyance surface 24B.

Accordingly, a step is formed at the boundary between the third reconveyance surface 24B and the first reconveyance surface 71B, the step being that the first reconveyance surface 71B is farther away from the reconveyance path P2 than the third reconveyance surface 24B. Thus, the sheet S conveyed along the reconveyance path P2 is not caught at the boundary between the third reconveyance surface 24B of the fuser chute 24 and the first reconveyance surface 71B of the movable chute 71, and the sheet S is smoothly conveyed.

In a state where the movable chute 71 is located at the second position, a rear end 25Aa of the guide frame 25, which is the upstream end of the second reconveyance surface 25A in the second direction D2, is located farther away from the reconveyance path P2 than the front end 71Bb of the movable chute 71, which is the downstream end of the first reconveyance surface 71B in the second direction D2. That is, the rear end 25Aa of the second reconveyance surface 25A is located above the front end 71Bb of the first reconveyance surface 71B.

Accordingly, a step is formed at the boundary between the first reconveyance surface 71B and the second reconveyance surface 25A, the step being that the second reconveyance surface 25A is farther away from the reconveyance path P2 than the first reconveyance surface 71B. Thus, the sheet S conveyed along the reconveyance path P2 is not caught at the boundary between the first reconveyance surface 71B of the movable chute 71 and the second reconveyance surface 25A of the guide frame 25, and the sheet S is smoothly conveyed.

Movement control of the movable chute will be described. As shown in FIG. 17, the image forming apparatus 1 includes a solenoid 92 as a drive source for moving the movable chute 71. The solenoid 92 is a solenoid actuator for moving the movable chute 71, which is urged toward the first position by the chute spring 74, from the first position toward the second position. The solenoid 92 is connected to the controller 95, and the controller 95 controls the operation of the solenoid 92. The controller 95 controls the movement of the movable chute 71 by controlling the operation of the solenoid 92. The pre-registration sensor 97, the post-registration sensor 98, and the sheet sensor 99 are connected to the controller 95.

After the leading edge of the sheet S conveyed along the conveyance path P1 passes the fuser 6, the controller 95 controls the solenoid 92 to move the movable chute 71 from the first position to the second position. The solenoid 92 is configured to move the movable chute 71 via a chute link 75, for example.

In this case, the controller 95 may determine that the leading edge of the sheet S has passed the fuser 6 when a particular time has elapsed since the post-registration sensor 98 detects the leading edge of the sheet S, and control the solenoid 92 to move the movable chute 71 from the first position to the second position. For example, when the solenoid 92 is driven by the controller 95 and is turned on, the movable chute 71 is pressed by the chute link 75 and moves from the first position to the second position against the urging force of the chute spring 74.

After the leading edge of the sheet S passes the fuser 6, the sheet S between the transfer unit 5A and the fuser 6 is bent (curved) because the conveyance speed of the sheet S by the transfer unit 5A is higher than the conveyance speed of the sheet S by the fuser 6. Thus, by moving the movable chute 71 toward the second position by the control of the controller 95, a large space is secured for a space in which the conveyance path P1 between the transfer unit 5A and the fuser 6 is located. This prevents the sheet S in which the bending occurs from interfering with (contacting) other components of the apparatus main body 2.

After the movable chute 71 is moved from the first position to the second position by the control of the controller 95, the movable chute 71 is maintained at the second position while the leading edge of the sheet S having passed the fuser 6 passes through the reconveyance path P2. Further, after the leading edge of the sheet S conveyed along the reconveyance path P2 passes the registration roller 35a, the solenoid 92 is controlled to move the movable chute 71 from the second position toward the first position.

In this case, for example, when a particular time has elapsed after the pre-registration sensor 97 detects the leading edge of the sheet S, the controller 95 may determine that the leading edge of the sheet S has passed the registration roller 35a and control the solenoid 92 to move the movable chute 71 from the second position toward the first position. For example, when the solenoid 92 becomes an OFF state by stopping the driving of the solenoid 92 by the controller 95, the pressing of the solenoid 92 is released, and the movable chute 71 moves from the second position to the first position by the urging force of the chute spring 74.

In a case where the movable chute 71 is moved from the first position toward the second position after the leading edge of the sheet S passes the fuser 6, after the state where the sheet S is conveyed by both the fuser 6 and the transfer unit 5A is released, the bending of the sheet S is eliminated. Thus, the movable chute 71 may be at the first position during a period from when the state where the sheet S is conveyed by both the fuser 6 and the transfer unit 5A is released until when the leading edge of the sheet S reaches the first reconveyance surface 71B of the movable chute 71.

However, when the movable chute 71 is moved to the second position, the reconveyance path P2 is formed by the first reconveyance surface 71B of the movable chute 71. Thus, the movable chute 71 may be maintained at the second position during a period from when the movable chute 71 is moved to the second position until the leading edge of the sheet S passes the registration roller 35a after the sheet S is conveyed along the reconveyance path P2. In this way, by maintaining the movable chute 71 at the second position until the leading edge of the sheet S passes the registration roller 35a, the movement control of the movable chute 71 is simplified.

A modification of movement control of the movable chute will be described. The controller 95 may control the movement of the movable chute 71 in the following manner.

After the leading edge of the sheet S conveyed along the conveyance path P1 passes the fuser 6, the controller 95 controls the solenoid 92 to move the movable chute 71 from the first position to the second position.

In this case, the controller 95 may determine that the leading edge of the sheet S has passed the fuser 6 when a particular time has elapsed since the post-registration sensor 98 detects the leading edge of the sheet S, and control the solenoid 92 to move the movable chute 71 from the first position to the second position.

Next, after the trailing edge of the sheet S conveyed along the conveyance path P1 passes the transfer unit 5A, the controller 95 controls the solenoid 92 to move the movable chute 71 from the second position to the first position.

In this case, the controller 95 may determine that the trailing edge of the sheet S has passed the transfer unit 5A when a particular time has elapsed since the post-registration sensor 98 detects the trailing edge of the sheet S, and control the solenoid 92 to move the movable chute 71 from the second position to the first position.

Further, before the leading edge of the sheet S conveyed along the reconveyance path P2 after passing through the fuser 6 and reversing the conveyance direction reaches the first reconveyance surface 71B of the movable chute 71, the controller 95 controls the solenoid 92 to move the movable chute 71 from the first position to the second position.

In this case, when a particular time has elapsed since the sheet sensor 99 detects the leading edge (before reversing the conveyance direction) of the sheet S, the controller 95 determines that the leading edge (after reversing the conveyance direction) of the sheet S reaches the first reconveyance surface 71B. Thus, before the particular time elapses since the sheet sensor 99 detects the leading edge of the sheet S, the controller 95 may control the solenoid 92 to move the movable chute 71 from the first position to the second position.

Then, after the leading edge of the sheet S conveyed along the reconveyance path P2 passes the registration roller 35a, the controller 95 controls the solenoid 92 to move the movable chute 71 from the second position to the first position.

In this case, for example, the controller 95 may determine that the leading edge of the sheet S has passed the registration roller 35a when a particular time has elapsed after the pre-registration sensor 97 detects the leading edge of the sheet S, and control the solenoid 92 to move the movable chute 71 from the second position to the first position.

In a configuration in which the movable chute 71 is moved to the second position by the solenoid 92, the solenoid 92 is in an ON state when the movable chute 71 is at the second position. Thus, if the movable chute 71 is continuously maintained at the second position during a period from when the leading edge of the sheet S passes the fuser 6 to when the leading edge of the sheet S passes through the reconveyance path P2, heat is generated from the solenoid 92 and the amount of current consumed by the solenoid 92 increases.

Thus, when the movable chute 71 does not need to be at the second position after the leading edge of the sheet S passes the fuser 6, the movable chute 71 is moved to the first position, which reduces the heat generation from the solenoid 92 and the current consumption by the solenoid 92.

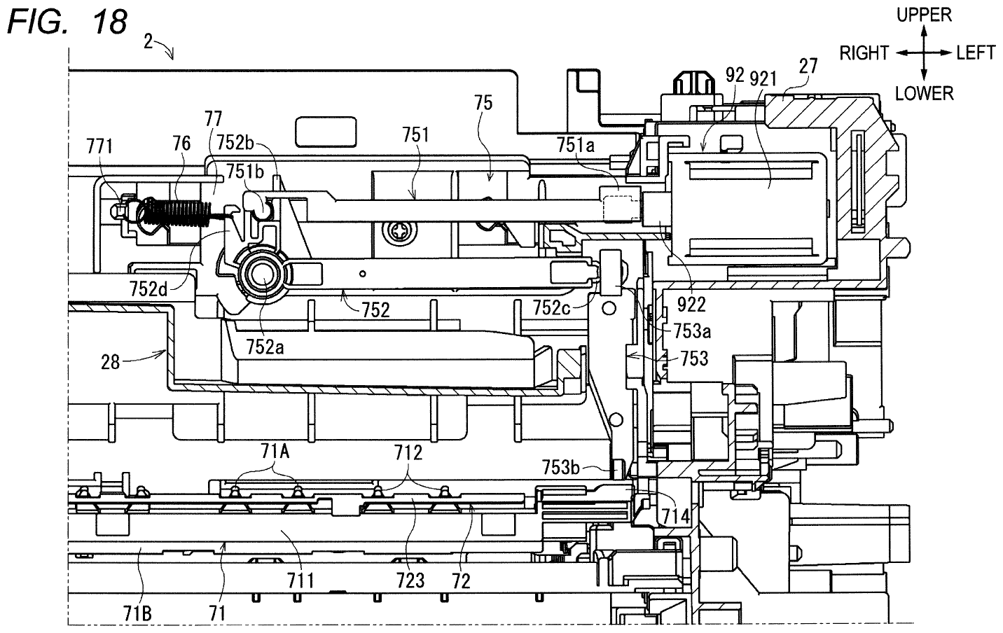

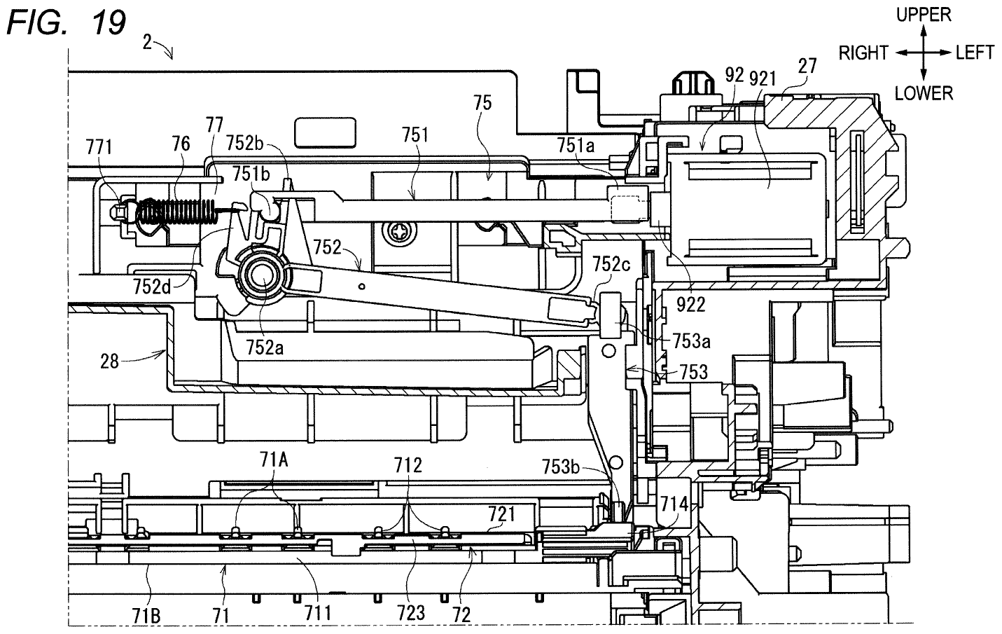

As shown in FIGS. 17 to 19, the chute link 75 is connected to the solenoid 92. The chute link 75 is driven by the solenoid 92 to press the movable chute 71, thereby moving the movable chute 71 from the first position to the second position.

The solenoid 92 includes a main body 921 supported by the second main body frame 27 and a plunger 922 movable in the left-right direction with respect to the main body 921. The plunger 922 is urged rightward from the main body 921 by an urging member. In an OFF state in which the solenoid 92 is not driven by the controller 95, the plunger 922 is in a state of being moved rightward and protruding from the main body 921. In an ON state in which the solenoid 92 is driven by the controller 95, the plunger 922 is pulled into the main body 921 and moved leftward.

The chute link 75 includes a first link 751, a second link 752, and a third link 753. The first link 751 and the second link 752 are located inside the air duct 28. The third link 753 protrudes downward from the inside of the air duct 28. A holder 77 for supporting the chute link 75 is attached to the inside of the air duct 28.

The first link 751 is an elongated member extending in the left-right direction and is supported by the holder 77 so as to be movable in the left-right direction. The first link 751 has a first end portion 751a which is a left end portion and a second end portion 751b which is a right end portion. The first end portion 751a is connected to the plunger 922 of the solenoid 92. The second end portion 751b contacts the second link 752.

The second link 752 is an elongated member extending in the left-right direction and is located below the first link 751. The second link 752 includes a pivot shaft portion 752a located at a right end, a contact portion 752b extending upward from the pivot shaft portion 752a, a tip end portion 752c which is a left end, and an engagement portion 752d extending obliquely upward and rightward from the pivot shaft portion 752a. The second link 752 is supported by the holder 77 so as to be pivotable about the pivot shaft portion 752a.

The image forming apparatus 1 includes a link spring 76 that urges the second link 752. The link spring 76 is attached to the holder 77. One end of the link spring 76 is engaged with a hook 771 of the holder 77, and the other end of the link spring 76 is engaged with the engagement portion 752d of the second link 752. The second link 752 is urged by the link spring 76 so as to pivot in a direction in which the tip end portion 752c moves upward. The contact portion 752b contacts the second end portion 751b of the first link 751. When the first link 751 moves leftward, the contact portion 752b is pressed leftward by the second end portion 751b, and the second link 752 pivots in a direction in which the tip end portion 752c moves downward.

The third link 753 is an elongated member extending in the upper-lower direction, and is disposed so as to be movable in the upper-lower direction. The third link 753 has a connecting portion 753a located at the upper end and a pressing portion 753b located at the lower end. The connecting portion 753a is connected to the tip end portion 752c of the second link 752. The pressing portion 753b is configured to press a pressed portion 714 of the movable chute 71.

As shown in FIGS. 9, 18, and 19, the pressed portion 714 of the movable chute 71 is formed on the sheet conveyance surface 71A side and faces upward. The sheet conveyance surface 71A of the movable chute 71 is formed in a region where the sheet S passes with respect to the left-right direction, and the pressed portion 714 is located outside the region where the sheet conveyance surface 71A is formed with respect to the left-right direction. In the present embodiment, the pressed portion 714 is located on the left side of the region where the sheet conveyance surface 71A is formed.

The pressing portion 753b of the third link 753 and the pressed portion 714 of the movable chute 71 face each other in the upper-lower direction. When the third link 753 moves downward, the pressing portion 753b presses the pressed portion 714 from above.

In the chute link 75 configured as described above, in an OFF state in which the solenoid 92 is not driven by the controller 95, the first link 751 connected to the plunger 922 is moved rightward, and the second link 752 is rotated in a direction in which the tip end portion 752c is moved upward by the urging force of the link spring 76.

The third link 753 is in a state of being moved upward by the second link 752, and the pressing portion 753b of the third link 753 and the pressed portion 714 of the movable chute 71 are separated from each other. The movable chute 71 is at the first position by the urging force of the chute spring 74.

In an ON state in which the solenoid 92 is driven by the controller 95, the first link 751 is moved leftward by the plunger 922 pulled by the main body 921. When the first link 751 moves leftward, the contact portion 752b of the second link 752 is pressed by the second end portion 751b of the first link 751, and the second link 752 pivots in a direction in which the tip end portion 752c moves downward against the urging force of the link spring 76.

The third link 753 moves downward in accordance with the pivotal movement of the second link 752, and the pressing portion 753b of the third link 753 presses the pressed portion 714 of the movable chute 71 downward, whereby the movable chute 71 moves from the first position to the second position against the urging force of the chute spring 74.

As described above, the chute link 75 is configured to move the movable chute 71 from the first position to the second position by being driven by the solenoid 92 in the ON state and pressing the movable chute 71 from above, that is, from the sheet conveyance surface 71A side. Thus, the movable chute 71 is moved from the first position to the second position quickly and stably.

Conversely, when the solenoid 92 in the ON state is switched to the OFF state, the chute link 75 is separated from the movable chute 71, and the movable chute 71 is moved from the second position to the first position by the urging force of the chute spring 74.

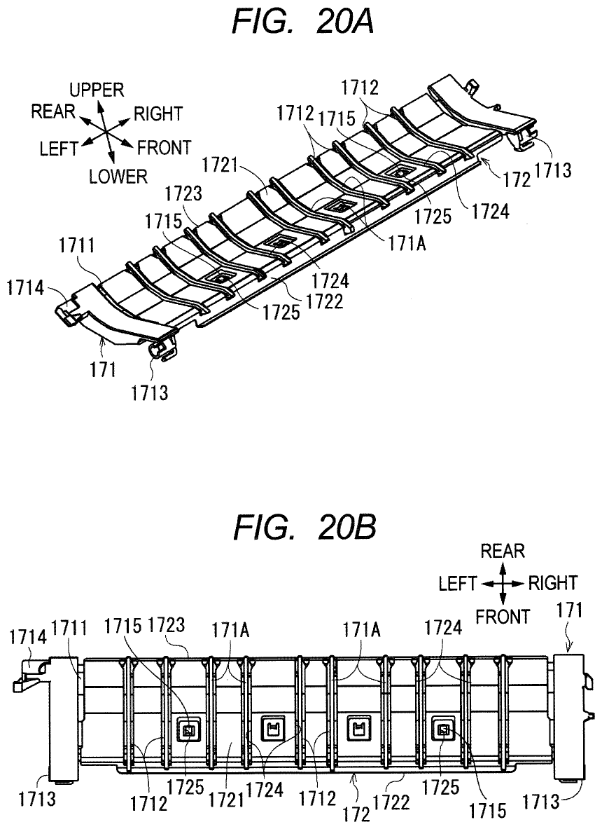

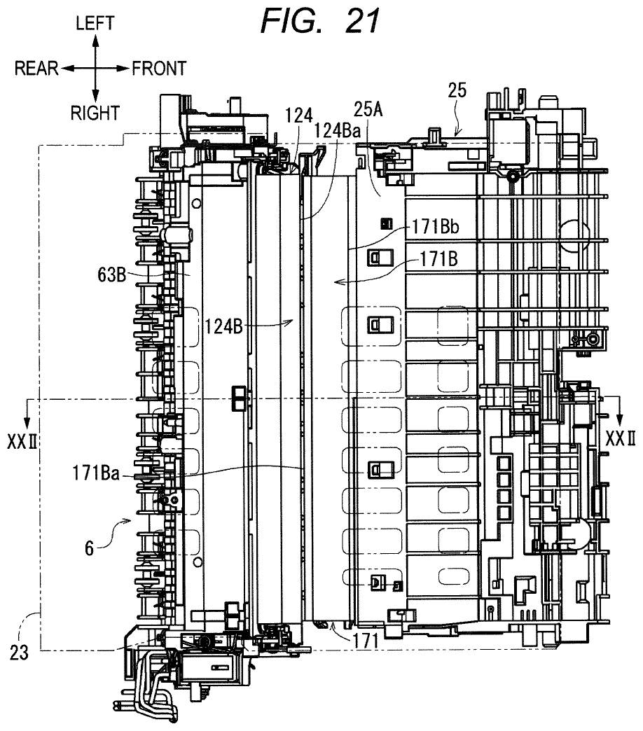

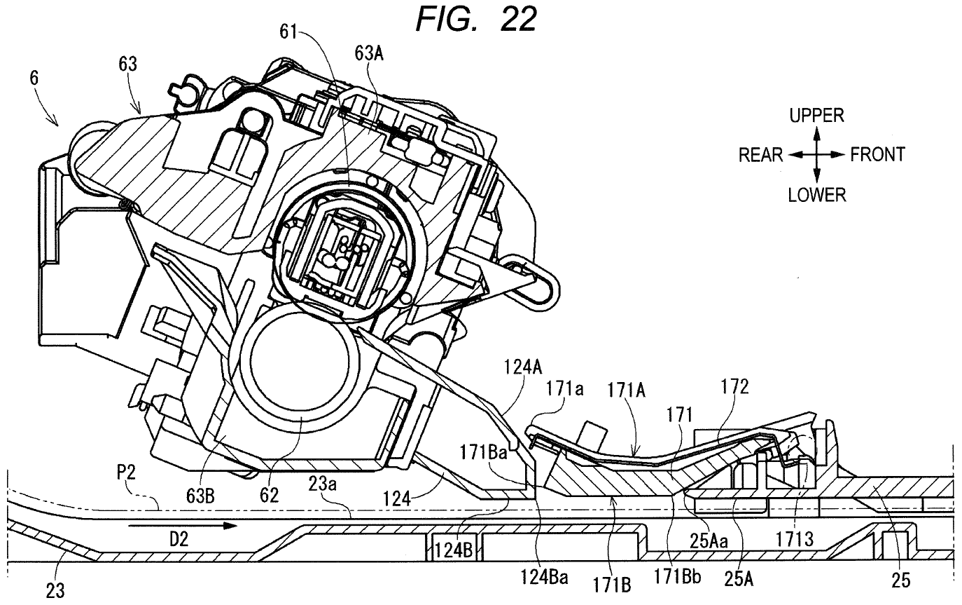

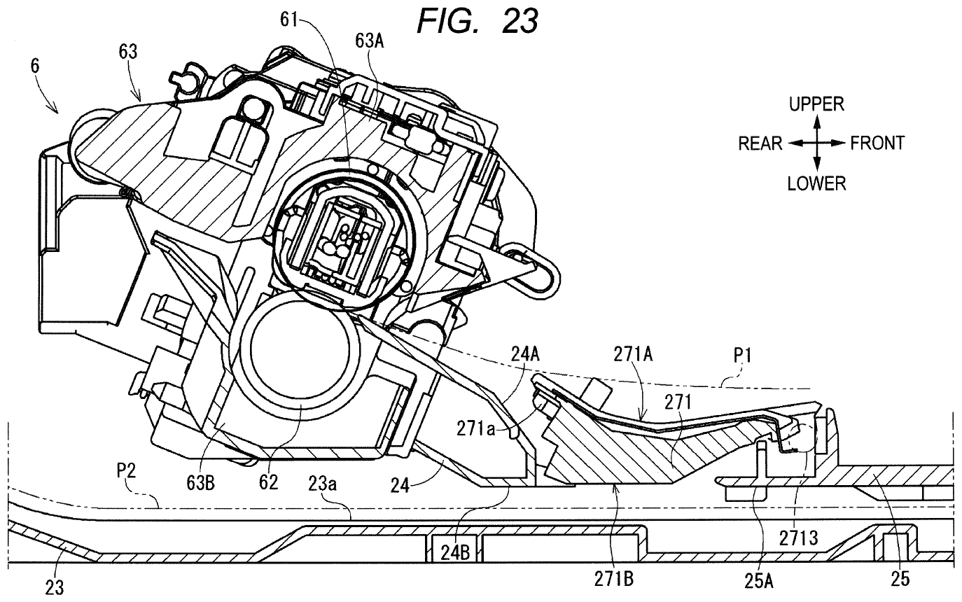

A second embodiment of the movable chute, the chute sheet metal, and the fuser chute will be described. The movable chute 71, the chute sheet metal 72, and the fuser chute 24 may be configured as a movable chute 171, a chute sheet metal 172, and a fuser chute 124 shown in FIGS. 20A, 20B, 21 and 22.

The movable chute 171 and the chute sheet metal 172 are different from the movable chute 71 and the chute sheet metal 72 which are fixed to each other by using the chute stopper 73, in that the movable chute 171 and the chute sheet metal 172 are fixed to each other without using a chute stopper.

The movable chute 171 includes a base 1711, guide ribs 1712, pivot shafts 1713, a pressed portion 1714, and hooks 1715. The hooks 1715 are formed on the upper surface of the base 1711.

The base 1711 is different from the base portion 711 in that the hooks 1715 are formed on the upper surface and the chute stopper 73 is not attached, and the other configurations are the same as those of the base portion 711.

The guide ribs 1712, the pivot shafts 1713, and the pressed portion 1714 are formed in the same manner as the guide ribs 712, the pivot shafts 713, and the pressed portion 714 of the movable chute 71, respectively. The upper surfaces of the guide ribs 1712 form a sheet conveyance surface 171A of the movable chute 171. The lower surface of the base 1711 forms a first reconveyance surface 171B of the movable chute 171.

The chute sheet metal 172 includes a base portion 1721, an upstream flange 1722, a downstream flange 1723, slits 1724, and engagement holes 1725. The base portion 1721, the upstream flange 1722, the downstream flange 1723, and the slits 1724 are formed in the same manner as the base portion 721, the upstream flange 722, the downstream flange 723, and the slits 724 of the chute sheet metal 72, respectively. The engagement holes 1725 are formed in the base portion 1721 and configured to engage with the hooks 1715 of the movable chute 171.

The chute sheet metal 172 is fixed to the movable chute 171 by engaging the hooks 1715 with the engaging holes 1725 in a state where the chute sheet metal 172 is superposed on the upper surface of the movable chute 171.

The first reconveyance surface 171B has a rear end 171Ba which is an upstream end in the second direction D2 and a front end 171Bb which is a downstream end in the second direction D2. Since no chute stopper is disposed on the first reconveyance surface 171B of the movable chute 171, the rear end 171Ba of the first reconveyance surface 171B is located at the same position in the front-rear direction over the entirety in the left-right direction.

The fuser chute 124 has a sheet conveyance surface 124A and a third reconveyance surface 124B. The fuser chute 124 is different from the fuser chute 24 in that a front end 124Ba of the third reconveyance surface 124B is located at the same position in the front-rear direction over the entirety in the left-right direction. In the fuser chute 24, the front end 24Ba of the central reconveyance surface 24BC protrudes forward from the front ends 24Ba of the left reconveyance surface 24BL and the right reconveyance surface 24BR. The other configuration of the fuser chute 124 is the same as that of the fuser chute 24.

The front end 124Ba of the third reconveyance surface 124B of the fuser chute 124 is located rearward of the rear end 171Ba of the first reconveyance surface 171B, and the fuser chute 124 and the movable chute 171 do not overlap each other in the front-rear direction.

No chute stopper is attached to the first reconveyance surface 171B of the movable chute 171, and the fuser chute 124 does not need to cover the lower side of the first reconveyance surface 171B. Thus, the sheet S is smoothly conveyed even though the fuser chute 124 and the movable chute 171 do not overlap in the front-rear direction.

The movable chute 171 is formed such that the rear end 171Ba of the first reconveyance surface 171B is located at the same position in the front-rear direction over the entirety in the left-right direction, and thus the shape of the movable chute 171 is simplified. The fuser chute 124 is formed such that the front end 124Ba of the third reconveyance surface 124B is located at the same position in the front-rear direction over the entirety in the left-right direction, and thus the shape of the fuser chute 124 is simplified.

In the movable chute 171 and the fuser chute 124, the rear end 171Ba of the first reconveyance surface 171B of the movable chute 171 is located farther from the reconveyance path P2 compared to the front end 124Ba of the third reconveyance surface 124B of the fuser chute 124. Thus, the sheet S is smoothly conveyed between the fuser chute 124 and the movable chute 171.

In the guide frame 25 and the movable chute 171, the rear end 25Aa of the second reconveyance surface 25A of the guide frame 25 is located farther from the reconveyance path P2 compared to the front end 171Bb of the first reconveyance surface 171B of the movable chute 171. Thus, the sheet S is smoothly conveyed between the movable chute 171 and the guide frame 25.

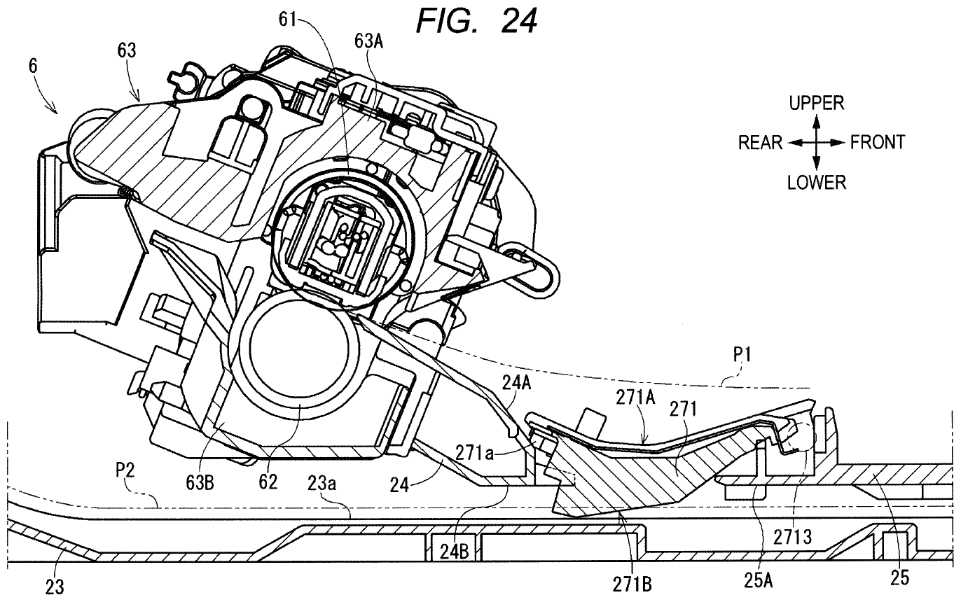

A third embodiment of the movable chute will be described. The movable chute 71 may be formed as a movable chute 271 shown in FIGS. 23 and 24.

The movable chute 271 has a sheet conveyance surface 271A facing upward and a first reconveyance surface 271B facing downward on the opposite side of the sheet conveyance surface 271A in the upper-lower direction. The sheet conveyance surface 271A guides, from below, the sheet S being conveyed along the conveyance path P1 toward the fuser 6. The first reconveyance surface 271B guides, from above, the sheet S being conveyed along the reconveyance path P2 toward the transfer unit 5A. The first reconveyance surface 271B forms an upper surface of the reconveyance path P2.

The movable chute 271 is pivotable about a pivot shaft 2713 located at the front end. The movable chute 271 is pivotable about the pivot shaft 2713 to be movable between a first position (position shown in FIG. 23) and a second position (position shown in FIG. 24) at which a downstream end 271a of the movable chute 271 in the first direction D1 is farther from the conveyance path P1 than at the first position.

The sheet conveyance surface 271A of the movable chute 271 guides the sheet S conveyed from the transfer unit 5A toward the fuser 6 when the movable chute 271 is located at the first position. The first reconveyance surface 271B of the movable chute 271 forms the reconveyance path P2 when the movable chute 271 is located at the first position.

When the movable chute 271 is located at the second position, the sheet conveyance surface 271A is located farther from the conveyance path P1 than when the movable chute 271 is located at the first position. When the movable chute 271 is located at the second position, the sheet conveyance surface 271A guides the sheet S bent (curved) toward the sheet conveyance surface 271A between the fuser 6 and the transfer unit 5A.

The position of the downstream end 271a of the movable chute 271 when the movable chute 271 is located at the second position is lower than the position of the downstream end 271a of the movable chute 271 when the movable chute 271 is located at the first position. Thus, when the movable chute 271 moves to the second position, a large space is secured in which the conveyance path P1 between the transfer unit 5A and the fuser 6 is located, which prevents the bent (curved) sheet S from interfering with (contacting) other components of the apparatus main body 2.

When the movable chute 271 is located at the second position, the first reconveyance surface 271B enters the reconveyance path P2. By configuring the first reconveyance surface 271B to enter the reconveyance path P2 when the movable chute 271 is located at the second position, the sheet conveyance surface 271A is moved to a position separated from the conveyance path P1 when the movable chute 271 is moved to the second position. This secures a space where the conveyance path P1 is located as large as possible in a limited space, and effectively absorbs bending (deflection) of the sheet S.

The movable chute 271 is configured such that the first reconveyance surface 271B forms the reconveyance path P2 when the movable chute 271 is located at the first position.

In this configuration, after the leading edge of the sheet S conveyed from the transfer unit 5A along the conveyance path P1 passes the fuser 6, the movable chute 271 is moved from the first position to the second position. Then, after the trailing edge of the sheet S passes the transfer unit 5A and before the leading edge of the sheet S reaches the first reconveyance surface 271B, the movable chute 271 is moved from the second position to the first position. By moving the movable chute 271 in this way, the sheet S is conveyed smoothly and efficiently.

In this configuration, the movable chute 271 may be configured to be moved without using the solenoid 92 and the chute link 75. In this case, the movable chute 271 may be moved from the first position to the second position by using force of the bent (curved) sheet S that presses the movable chute 271, the sheet S being conveyed from the transfer unit 5A along the conveyance path P1. Further, when the trailing edge of the sheet S passes the transfer unit 5A, the bending of the sheet S is eliminated, and the pressing force of the sheet S against the movable chute 271 is eliminated, which causes the movable chute 271 to be moved from the second position to the first position by the chute spring 74. Thus, the sheet S is smoothly and efficiently conveyed without performing the movement control of the movable chute 271.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided as appropriate.

What is claimed is:

1. An image forming apparatus comprising:
a transfer unit configured to transfer a toner image onto a sheet;
a fuser including a heater and configured to fix the toner image on the sheet conveyed from the transfer unit;
a movable chute located downstream of the transfer unit and upstream of the fuser in a first direction, the first direction being a sheet conveyance direction from the transfer unit toward the fuser, the movable chute having a downstream end in the first direction, the movable chute being movable between a first position and a second position different from the first position, the downstream end of the movable chute located at the second position being farther from a sheet conveyance path than the downstream end of the movable chute located at the first position, the sheet conveyance path being formed along the first direction; and
a reconveyance chute configured to guide the sheet having passed the fuser to the transfer unit, the reconveyance chute forming a reconveyance path of the sheet that is reconveyed from the fuser toward the transfer unit, the reconveyance path being located between the movable chute and the reconveyance chute in a sheet thickness direction of the sheet,
the movable chute having a sheet conveyance surface and a first reconveyance surface, the sheet conveyance surface being configured to guide the sheet that is conveyed from the transfer unit toward the fuser along the sheet conveyance path, the first reconveyance surface facing opposite to the sheet conveyance surface in the sheet thickness direction, the first reconveyance surface forming the reconveyance path.

2. The image forming apparatus according to claim 1, wherein the first reconveyance surface forms the reconveyance path when the movable chute is located at the second position.

3. The image forming apparatus according to claim 2, further comprising:
a drive source configured to move the movable chute; and
a controller configured to control the drive source,
wherein the controller is configured to:
after a leading edge of the sheet conveyed along the sheet conveyance path passes the fuser, control the drive source to move the movable chute from the first position toward the second position.

4. The image forming apparatus according to claim 3, further comprising:
a registration roller located upstream of the transfer unit in the first direction, the registration roller being configured to correct a skew of the sheet that is conveyed toward the transfer unit,
wherein the controller is configured to:
after the leading edge of the sheet conveyed along the sheet conveyance path passes the fuser, control the drive source to move the movable chute from the first position toward the second position;
while a leading edge of the sheet having passed the fuser and having reversed passes through the reconveyance path, maintain the movable chute at the second position; and
after the leading edge of the sheet conveyed along the reconveyance path passes the registration roller, control the drive source to move the movable chute from the second position toward the first position.

5. The image forming apparatus according to claim 3, further comprising:
a registration roller located upstream of the transfer unit in the first direction, the registration roller being configured to correct a skew of the sheet that is conveyed toward the transfer unit,
wherein the controller is configured to:
after the leading edge of the sheet conveyed along the sheet conveyance path passes the fuser, control the drive source to move the movable chute from the first position toward the second position;
after a trailing edge of the sheet conveyed along the sheet conveyance path passes the transfer unit, control the drive source to move the movable chute from the second position toward the first position;
before a leading edge of the sheet having passed the fuser and having reversed and being conveyed along the reconveyance path reaches the first reconveyance surface, control the drive source to move the movable chute from the first position toward the second position; and
after the leading edge of the sheet conveyed along the reconveyance path passes the registration roller, control the drive source to move the movable chute from the second position toward the first position.

6. The image forming apparatus according to claim 1, further comprising:
a solenoid actuator configured to move the movable chute; and
a chute link connected to the solenoid actuator and configured to move the movable chute from the first position to the second position,
wherein the chute link is configured to be driven by the solenoid actuator to press the movable chute from a side of the sheet conveyance surface, thereby moving the movable chute from the first position to the second position.

7. The image forming apparatus according to claim 1, further comprising:
a guide frame supporting the movable chute so as to be swingable, the guide frame being located upstream of the movable chute in the first direction, the guide frame having a second reconveyance surface forming the reconveyance path; and
a fuser chute located upstream of the fuser and downstream of the movable chute in the first direction, the fuser chute having a third reconveyance surface forming the reconveyance path.

8. The image forming apparatus according to claim 7, wherein the fuser chute and the movable chute overlap in a sheet conveyance direction of the sheet that is conveyed along the reconveyance path.

9. The image forming apparatus according to claim 7, wherein an upstream end of the first reconveyance surface of the movable chute in a second direction is located farther from the reconveyance path than a downstream end of the third reconveyance surface of the fuser chute in the second direction, the second direction being a sheet conveyance direction of the sheet that is conveyed toward the transfer unit along the reconveyance path.

10. The image forming apparatus according to claim 7, wherein an upstream end of the second reconveyance surface of the guide frame in a second direction is located farther from the reconveyance path than a downstream end of the first reconveyance surface of the movable chute in the second direction, the second direction being a sheet conveyance direction of the sheet that is conveyed toward the transfer unit along the reconveyance path.

11. The image forming apparatus according to claim 1, wherein a downstream end of the movable chute in the first direction when the movable chute is located at the second position is located at a lower position than the downstream end of the movable chute in the first direction when the movable chute is located at the first position.

12. The image forming apparatus according to claim 11, wherein the sheet thickness direction is an upper-lower direction; and
wherein the movable chute is located above the reconveyance chute, the movable chute forming an upper surface of the reconveyance path.

13. The image forming apparatus according to claim 6, wherein the chute link is configured to move the movable chute from the first position to the second position by pressing the movable chute from above.

14. The image forming apparatus according to claim 12, further comprising:
a guide frame supporting the movable chute so as to be swingable, the guide frame located upstream of the movable chute in the first direction, the guide frame having a second reconveyance surface facing the reconveyance path; and
a fuser chute located upstream of the fuser and downstream of the movable chute in the first direction, the fuser chute having a third reconveyance surface facing the reconveyance path,
wherein the second reconveyance surface of the guide frame and the third reconveyance surface of the fuser chute form an upper surface of the reconveyance path.

15. The image forming apparatus according to claim 14, wherein the first reconveyance surface of the movable chute and the third reconveyance surface of the fuser chute overlap as viewed from a sheet width direction, the sheet width direction crossing the first direction and the upper-lower direction.

16. The image forming apparatus according to claim 7, further comprising:
a sheet metal member supported by the movable chute; and
a stopper attached to the movable chute from a side of the first reconveyance surface, the stopper fixing the sheet metal member to the movable chute,
wherein the stopper and the fuser chute overlap as viewed from the sheet thickness direction.

17. The image forming apparatus according to claim 1, wherein the first reconveyance surface forms the reconveyance path when the movable chute is located at the first position.

18. The image forming apparatus according to claim 17, wherein the movable chute is configured to enter the reconveyance path when the movable chute is located at the second position.

19. The image forming apparatus according to claim 1, further comprising:
a fuser chute located upstream of the fuser and downstream of the movable chute in the first direction,
wherein a central part of the fuser chute in a sheet width direction protrudes in a direction in which the sheet is conveyed along the reconveyance path, the sheet width direction crossing the first direction and the sheet thickness direction; and
wherein the central part of the fuser chute and the movable chute overlap as viewed from the sheet thickness direction.

20. The image forming apparatus according to claim 1, further comprising:
a sheet metal member supported by the movable chute,
wherein the movable chute includes:
a base member; and
a guide rib protruding from the base member and extending in the first direction, an end surface of the guide rib forming the sheet conveyance surface; and
wherein the sheet metal member is formed with a slit extending in the first direction, the guide rib being inserted through the slit, the sheet metal member being connected to ground.
